(19) United States
(12) Patent Application Publication
(10) Pub. No.: US 2021/0190742 A1
(43) Pub. Date: Jun. 24, 2021

(54) INTELLIGENT COMPOSITIONS, PACKAGING, AND METHODS THEREOF

(71) Applicant: Braskem S.A., Camacari (BR)

(72) Inventors: Murilo Lauer Sanson, Sao Paulo (BR); Mariele Kaipers Stocker, Sao Paulo (BR); Rodrigo Brambilla, Sao Paulo (BR); Arthur Alaim Bernardes, Sao Paulo (BR); Marcia Pires Fortes Ferreira, Sao Paulo City (BR); Leonardo Batista Ito, Sao Paulo (BR)

(73) Assignee: Braskem S.A., Camacari (BR)

(21) Appl. No.: 16/721,237

(22) Filed: Dec. 19, 2019

(51) Int. Cl. G01N 31/22; C08K 9/10; B33Y 70/10; B65D 65/40

(52) U.S. Cl. CPC G01N 31/22; B65D 65/40; B33Y 70/10; C08K 9/10

(57) ABSTRACT

Packaging materials may include a packaging material formed from an intelligent polymer composition, wherein the intelligent polymer composition includes a matrix polymer and an indicator, wherein the indicator triggers a color change in the intelligent polymeric composition when exposed to an external stimulus, and wherein the intelligent polymer composition is configured to contact a material enclosed within the packaging material. Methods may include forming a packaging material from an intelligent polymer composition, wherein the intelligent polymer composition includes a matrix polymer and an indicator, wherein the indicator triggers a color change in the intelligent polymeric composition when exposed to an external stimulus, and wherein the intelligent polymer composition is configured to contact a material enclosed within the packaging material.

### BACKGROUND

The growing search for intelligent polymer materials with the ability to respond to changes in the environment and visually communicate the chemical status surrounding the polymer has driven the development of new technologies, particularly in food packaging technologies. In the last decades, many studies have been developed aiming for the production of intelligent packaging to ensure food safety, quality and traceability. The packaging industry searches for objective systems and aims to guarantee quality and safety of the food, in addition to ensuring consumer confidence. In general, the systems used are accessories incorporated or fixed in the packages, such as labels, adhesives, and sensors.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an encapsulated indicator that includes a silica matrix encapsulating an acid-base indicator, wherein the acid-base indicator is present in its basic form.

In another aspect, embodiments disclosed herein relate to an intelligent polymer composition that includes a polymer matrix; and an encapsulated indicator dispersed in the polymer matrix, wherein the encapsulated indicator includes a silica matrix encapsulating an acid-base indicator, wherein the acid-base indicator is present in its basic form.

In another aspect, embodiments disclosed herein relate to an intelligent polymer composition that includes a matrix polymer and an encapsulated indicator, wherein the indicator triggers a color change in the intelligent polymeric composition when exposed to an external stimulus.

In yet another aspect, embodiments disclosed herein relate to a packaging material that includes a packaging material formed from an intelligent polymer composition that includes a polymer matrix; and an encapsulated indicator dispersed in the polymer matrix, wherein the encapsulated indicator includes a silica matrix encapsulating an acid-base indicator, wherein the acid-base indicator is present in its basic form, and wherein the intelligent polymer composition is configured to contact a material enclosed within the packaging material

In yet another aspect, embodiments disclosed herein relate to a packaging material that includes a packaging material formed from an intelligent polymer composition that includes a matrix polymer and an encapsulated indicator, wherein the indicator triggers a color change in the intelligent polymeric composition when exposed to an external stimulus, and wherein the intelligent polymer composition is configured to contact a material enclosed within the packaging material.

In another aspect, embodiments disclosed herein relate to a method of forming encapsulated indicator that includes reacting at least one acid-base indicator with a non-volatile alkaline compound to convert the acid-base indicator to its basic form; combining the acid-base indicator with a silica precursor; and precipitating the silica precursor to form a silica matrix encapsulating the acid-base indicator.

In yet another aspect, embodiments disclosed herein relate to a method of forming an intelligent polymer composition that includes dispersing an encapsulated indicator in a polymer matrix to form the intelligent polymer composition that includes a polymer matrix; and an encapsulated indicator dispersed in the polymer matrix, wherein the encapsulated indicator includes a silica matrix encapsulating an acid-base indicator, wherein the acid-base indicator is present in its basic form.

In yet another aspect, embodiments disclosed herein relate to a method of forming an intelligent polymer composition that includes dispersing an encapsulated indicator in a polymer matrix to form the intelligent polymer composition that includes a matrix polymer and an encapsulated indicator, wherein the indicator triggers a color change in the intelligent polymeric composition when exposed to an external stimulus.

In another aspect, embodiments disclosed herein relate to method that includes forming a packaging material from an intelligent polymer composition that includes a polymer matrix; and an encapsulated indicator dispersed in the polymer matrix, wherein the encapsulated indicator includes a silica matrix encapsulating an acid-base indicator, wherein the acid-base indicator is present in its basic form.

In another aspect, embodiments disclosed herein relate to method that includes forming a packaging material from an intelligent polymer composition that includes a matrix polymer and an encapsulated indicator, wherein the indicator triggers a color change in the intelligent polymeric composition when exposed to an external stimulus.

In yet another aspect, embodiments disclosed herein relate to a method that includes manufacturing at least a first portion of an entire article using an additive manufacturing technique with an intelligent polymer composition, wherein the intelligent polymer composition comprises a matrix polymer and an indicator, wherein the indicator triggers a color change in the intelligent polymeric composition when exposed to an external stimulus.

In yet another aspect, embodiments disclosed herein relate to a printed article that includes a plurality of printed layers, with at least a portion of the plurality of layers comprising an intelligent polymer composition, wherein the intelligent polymer composition comprises a matrix polymer and an indicator, wherein the indicator triggers a color change in the intelligent polymeric composition when exposed to an external stimulus.

Other aspects and advantages of the claimed subject matter will be apparent from the following description and the appended claims.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIGS. 1A-B are schematics illustrating a bottle cap containing an intelligent polymer composition in accordance with embodiments of the present disclosure.

FIGS. 2A-B are schematics illustrating packaging incorporating an intelligent polymer composition in accordance with embodiments of the present disclosure.

FIGS. 3-6 are schematics illustrating various packaging configurations for incorporating an intelligent polymer composition in accordance with embodiments of the present disclosure.

FIG. 7 shows ATR-FTIR spectrum of silica capsules according to embodiments of the present disclosure.

FIGS. 8-14 shows an SEM image of silica capsules according to embodiments of the present disclosure.

FIGS. 15-16 show color change progression for different molar ratios of indicator ro alkaline.

FIG. 17 shows delta E over time for Examples 1-3 of the present disclosure.

FIG. 18 shows delta E over time for Examples 2 and 3 of the present disclosure.

FIG. 19 shows photographs of a 3D-printed bottle according to embodiments of the present disclosure.

### DETAILED DESCRIPTION

In one aspect, embodiments disclosed herein relate to encapsulated indicators that function as visual indicators in response to changes in the surrounding environment. In accordance with one or more embodiments of the present disclosure, indicators encapsulated in silica may be converted during synthesis of the silica capsules to the high end of the indicator's pH scale.

In another aspect, embodiments disclosed herein relate to intelligent polymer compositions that contain an indicator therein that responds to changes in the surrounding environment. Particular embodiments of intelligent polymer compositions (including both neat (unmodified) or encapsulated indicators) may be used in additive manufacturing, though other embodiments may be directed to encapsulated indicators used in any manufacturing processes. Intelligent polymer compositions in accordance with the present disclosure may optionally form all or at least a portion of a packaging material, including components that are made separately and combined with a second packaging material prepared by a separate process. In one or more embodiments, intelligent polymer compositions may be formulated as a color-based pH indicator, such as for use in food packaging containing the color-based pH indicator, that is capable of detecting pH changes, such as in enclosed foods associated with various forms of microbe-induced spoilage, for example.

In one or more embodiments, intelligent polymer compositions may contain a polymer matrix prepared from a polymer or polymer mixture, and an indicator capable of detecting the pH of substances enclosed within a package constructed, at least in part, from the intelligent polymer composition and communicating by color change to an external observer. For example, intelligent polymer compositions may include a pH indicator that detects pH changes in a range from 4 to 6, and may be constructed as a food container used to store milk and other dairy products.

Indicators in accordance with the present disclosure may include indicators embedded within a suitable host material. In some embodiments, matrix polymers in accordance with the present disclosure may be formulated to control the rate of diffusion of gases and liquids carrying triggering stimuli into the polymer matrix of the intelligent polymer composition. For example, tuning the diffusion or permeability properties of a polymer composition may control the diffusion of external stimuli, such as acids, bases, and organics, into the polymer matrix to be detected by an indicator. In addition, diffusion of a polymer matrix may be modified to limit or eliminate leakage of the indictors into the surrounding environment.

Intelligent polymer compositions in accordance with one or more embodiments of the present disclosure may include an encapsulated indicators embedded within an encapsulant matrix that may extend the useful life of intelligent polymer compositions in some applications, for example, by maintaining the concentration and brightness/apparent intensity of a color indicator. Indicators are often small molecules or molecular complexes, which may diffuse through pores created in a polymer network and escape into the surrounding media. By encapsulating an indicator in an encapsulant matrix such as a silica matrix, diffusion of the indicator out of the polymer media may be controlled. In addition, an encapsulating matrix may be used to tune the sensitivity of an intelligent polymer composition by modifying the rate of diffusion of a chemical stimulus into the polymer matrix. The encapsulant matrix may also prevent degradation of indicators during polymer processing conditions, which may include elevated temperatures and shear stresses during processing techniques such as extrusion.

Intelligent polymer compositions in accordance with the present disclosure may include (1) a matrix polymer, which may be a single polymer or blend of polymers; and (2) an intelligent additive, which may be encapsulated or non-encapsulated, depending on the application. That is, for example, in particular embodiments directed to intelligent polymer compositions used in additive manufacturing, it is envisioned that either encapsulated or non-encapsulated indicators may be used.

In some embodiments, polymer compositions may include a number of additives that modify physical properties of the polymer composition such as adjusting melt flow, hardness, pH detection range, and the like. In some embodiments, intelligent polymer compositions in accordance with the present disclosure may be formulated to resist surface fouling by proteins and other hydrophobic compounds that may reduce detection sensitivity. For example, the hydrophobicity of the matrix polymer in a composition may be modified to control the accumulation of proteins present in milk and other foodstuffs on a matrix polymer surface.

In one or more embodiments, the indicators hosted in silica capsules and polymeric formulations in which these capsules are dispersed can both be used as sensors for food, pharmaceutical, environmental, and analytical industries.

Indicator

Intelligent compositions in accordance with the present disclosure may include one or more converted indicators and non-converted indicators (optionally encapsulated, depending on the application) that are sensitive to external stimuli such as changes in pH, humidity, time, and the presence of acids and bases. When subjected to the appropriate stimuli, the converted indicator may exhibit visual changes, for example a color change, indicating that a change of a predetermined magnitude has occurred. In one or more embodiments, the indicator may be a converted pH indicator and/or an indicator which changes color in the presence of an analyte, such as ammonia, sulfur derivatives, ethylene, amines, indole, escathol, acids (e.g., lactic acid, gluconic acid, or acetic acid) and combinations thereof. It is also envisioned that multiple indicators may be included in a polymer composition, where each indicator is sensitive to a different stimulus.

In one or more embodiments, acid-base indicators may be one or more selected from Methyl Violet, Crystal Violet, Ethyl Violet, Malachite Green, 2-((p-(dimethylamino) phenyl) azo) pyridine, Quinaldine Red, para-methyl Red, Litmus, Metanil Yellow, 4-phenylazodiphenylamine, Thymol blue, m-Cresol Purple, Tropaeolin 00, 4-o-tolylazo-o-toluidine, Erythrosine sodium salt, Benzopurpurin 4B, N,N′-dimethyl-p-(m-tolylazo) Aniline, 2,4-Dinitrophenol, Methyl Yellow (N,N-Dimethyl-p-phenylazoaniline), 4,4′-bis(2-amino-1-naphthylazo)2,2′-stilbenedisulfonic acid, potassium salt of tetrabromophenolphthalein ethyl ester, Bromophenol blue, Congo red, Methyl Orange, Methyl orange xylene cyanol solution, Ethyl orange, 2-((p-(dimethylamino)phenyl)azo)pyridine,4-(p-ethoxyphenylazo)-m-phenyl enediamine monohydrochloride, Methyl Red, Lacmoid, Bromocresol Purple, Bromothymol Blue, Phenol Red, Metacresol Purple, Thymol Blue, Phenolphthalein, Thymolphthalein, Alizarin Yellow R, Carmine of Indigo, 2,5-Dinitrophenol, Bromocresol Green, Chlorophenol Red, Bromophenol Red, Neutral Red, Rosolic Acid, Cresol Red, o-cresolphthalein, tropaeolin o, 4-nitrophenol, anthocyanins, ferroin, n-phenylanthranilic Acid, Resazurin, fast green, yellow twilight, bright blue, bordeaux, tartasin, red 40, erythrosine, anthocyanin, curcumin, cochineal carmine, saffron, azorubine, capsanthin, carmine hydro, indigotine, pinachrome, ponseau 4R, Resorcinmalein, rodol green, riboflavin, beet red, heptamethoxy red, hexametoxy red, propyl red, beta carotene, and mixtures thereof. For example, as shown in Table 1, various examples of indicators having the corresponding scape of pH transition is shown.

TABLE 1

| | Low pH | Transition | Transition | High pH |
|---|---|---|---|---|
| Indicator | color | low end | high end | color |
| Alizarine Yellow R | Yellow | 10.2 | 12.0 | Red |
| Azolitmin | Red | 4.5 | 8.3 | Blue |
| Bromocresol green | Yellow | 3.8 | 5.4 | Blue |
| Bromocresol purple | Yellow | 5.2 | 6.8 | Purple |
| Bromophenol blue | Yellow | 3.0 | 4.6 | Blue |
| Bromothymol blue | Magenta | <0 | 6.0 | yellow |
| (first transition) | | | | |
| Bromothymol blue | Yellow | 6.0 | 7.6 | Blue |
| (second transition) | | | | |
| Congo red | Blue- | 3.0 | 5.0 | Red |
| | violet | | | |
| Cresol red | Yellow | 7.2 | 8.8 | Reddish- |
| | | | | purple |
| Cresolphthalein | Colorless | 8.2 | 9.8 | Purple |
| Gentian violet | Yellow | 0.0 | 2.0 | Blue- |
| (methyl violet 10B) | | | | violet |
| Indigo camine | Blue | 11.4 | 13.0 | Yellow |
| Malachite green | Yellow | 0.0 | 2.0 | Green |
| (first transition) | | | | |
| Malachite green | Green | 11.6 | 14.0 | Green |
| (second transition) | | | | |
| Methyl orange | Red | 3.1 | 4.4 | Yellow |
| Methyl purple | Purple | 4.8 | 5.4 | Green |
| Methyl red | Red | 4.4 | 6.2 | Yellow |

In the present disclosure, the terms “basic” and “basic form” of an indicator have the meaning that the indicator is in the form (“color”) of its transition that is on the higher end of its pH scale. For example, if a pH indicator has a low end transition at a pH value of 1 and a high end at a pH value of 3, when its color corresponds to the color for a pH value higher than 3, it has reached its higher end, and it is called “basic form”, even though the pH at which the high end transition occurs is an acidic pH. Similarly, for pH indicators having a low end transition that is at a basic pH, the basic form of the indicator is present when the indicator has transitioned to the higher end form, with a color corresponding to a pH value at the higher end transition.

In one or more embodiments, an indicator may be converted to an active form that reacts with a triggering stimulus, undergoing a color change. For example, a pH indicator used to indicate the presence of an acid may be obtained in an acid form from a supplier or following synthesis and exhibit a color corresponding to an acid state. In one or more embodiments, in order to have the indicator function to detect acid, the indicator may be converted (or charged) to the corresponding basic form and color by treatment with a strong base. During operation, contact with an acidic material, such as acetic acid or lactic acid produced by various microbes, initiates a color change for the material, providing a visual indicator of food spoilage. First, the acids compounds may neutralize the base used in the indicator conversion, and then as the acid continues to build up, the acid may react with the indicator, thereby changing its color. For example, a bromothymol blue indicator may be converted with alkaline base to its characteristic blue color in high pH. Upon neutralization of any base remaining, generated acids may convert the indicator from blue to yellow, providing a visual indicator, for example, of food spoilage.

Thus, it is specifically envisioned that different concentration ratios between indicator and alkaline base may be used to convert the indicator, which may allow for control and modulation of the speed of the indicator's color change depending on the concentration of the trigger (acid) that is generated. While the present disclosure refers to the generation of acid during a food decomposition process, the present disclosure is not so limited. Rather, it is understood that other process can release acidic compounds, and the embodiments of the present disclosure may be able to detect acidic vapors and solutions.

The selected indicator for an intelligent polymer composition may be converted at any stage during the process of preparing the intelligent polymer composition, including prior to or after combination with the matrix polymer. Further, in one or more embodiments, the indicator may be converted prior, during, or after encapsulation, and prior to or after combination of the encapsulated indicator with the matrix polymer.

The conversion of indicator may allow modulation of the response to stimuli over a period of time according to the concentration of the trigger generated in any process, such as aging and deterioration of different kinds of food. According to the nature and concentration of the base performing the conversion, the response rate (color change) of the indicator that is hosted in a capsule can be adjusted.

In one or more embodiments, indicators may be added to an intelligent polymer composition at a concentration having a lower limit selected from any of 10 ppm, 100 ppm, and 500 ppm, to an upper limit selected from any of 1,000 ppm, 5,000 ppm, 10,000 ppm, and 20,000 ppm, where any lower limit may be combined with any upper limit. However, more or less indicator may be added depending on the particular application, and the conversion of the indicator can be modulated in accordance with the present disclosure.

Indicator Encapsulation

As mentioned above, in one or more embodiments, one or more indicators may be encapsulated prior to incorporation into an intelligent composition. Indicators in accordance with the present disclosure may optionally be encapsulated by an encapsulant that prevents the indicator from leaching into the surrounding polymer or environment, and/or protects the indicator from substantial degradation due to polymer processing conditions, but also allows diffusion of substances into the encapsulated indicator that trigger a color change. The encapsulant of the present disclosure, by its intrinsic characteristics, may allow contact between an analyte and the indicator and, on the other hand, substantially inhibit the release of the indicator to the medium. In other words, the encapsulant protects the indicator, substantially avoiding or minimizing its leaching into the external environment.

The encapsulant in which the indicator is encapsulated may be an organic, inorganic or hybrid matrix. In one or more embodiments, indicators may be encapsulated by a matrix formed by the reaction of an encapsulant precursor such as silicon alkoxides or titanium alkoxides in some embodiments, or mixtures of silicone alkoxides and titanium alkoxides in other embodiments, which react to form a matrix that modifies the rate at which the indicator may leach into the surrounding polymer or environment and also protects the indicator from substantial degradation due to the polymer processing conditions.

In some embodiments, encapsulants may be prepared according to a sol-gel method, such as that described in U.S. Pat. No. 9,063,111, but not limited to the precursors described therein. In some embodiments, alkoxide substituents of the encapsulant precursors may include C1-C12 alcohols, which may be linear or branched and may be substituted with various functional groups such as vinyl groups, alkyls, amines, amides, imines, carboxylates, and alcohols. For example, a silica-based encapsulant may be modified to contain amine functionality by reaction with modified alkoxysilanes such as aminopropyltriethoxysilane (APTS).

In one or more embodiments, the indicator may be converted to an active form that reacts with a triggering stimulus, undergoing a color change, prior, during or after the encapsulation, forming an encapsulated converted indicator.

In one or more embodiments, the encapsulant is a modified encapsulant comprising functional groups that can convert the encapsulated indicator to an active form, forming an indicator converted by capsule chemistry. For example, a pH indicator used to indicate the presence of an acid may be obtained in an acid form from a supplier or following synthesis and exhibit a color corresponding to an acid state. In order to have the indicator function to detect acid, the indicator may be encapsulated in an encapsulant comprising functional groups that stabilizes the corresponding basic form and color by the presence of basic functional groups in the encapsulant. For example, a bromothymol blue indicator may be encapsulated in a silica-based encapsulant modified to contain amine functionality, converting the indicator to the corresponding basic form and characteristic blue color. During operation, contact with an acidic material, such as acetic acid or lactic acid produced by various microbes initiates a color change for the material from blue to yellow, providing a visual indicator of food spoilage.

Embodiments of the present disclosure are also directed to methods of encapsulating the indicator in a matrix of silica through sol-gel routes. In one or more embodiments, the sol-gel route may be via a basic catalysis, referred to as route (a), or a two-step basic/acidic catalysis, referred to as route (b).

Encapsulation Route (a)

The encapsulation process of the indicator via basic catalysis sol-gel route (a) comprises the following steps: i) Reacting the acid-base indicator or a mixture of acid-base indicators in their acid form with a non-volatile alkaline compound in an alcoholic medium; ii) Adding a volatile alkaline compound, such as ammonium hydroxide to the solution obtained in i); iii) Adding a tetralkylorthosilicate to the solution obtained in ii) to result in a chemical reaction of silica formation and the encapsulation of the indicator; iv) Removing the solvent of the product from the reaction obtained in iii); and optionally, v) Washing the product obtained in iv) with an alcohol and drying.

Step i) of the indicator encapsulation route (a) may involve reacting the acid-base indicator or a mixture of acid-base indicators in their acid form with an aqueous solution of a non-volatile alkaline compound in an alcoholic medium. In one or more embodiments, in step i), the alkaline compound may be a strong base used to convert the indicator to its basic form.

Representative but non-limiting examples of the acid-base indicator used in step i) of route (a) include: Methyl Violet, Crystal Violet, Ethyl Violet, Malachite Green, 2-((p-(dimethylamino) phenyl) azo) pyridine, Quinaldine Red, para-methyl Red, Litmus, Metanil Yellow, 4-phenylazodiphenylamine, Thymol blue, m-Cresol Purple, Tropaeolin 00, 4-o-tolylazo-o-toluidine, Erythrosine sodium salt, Benzopurpurin 4B, N,N′-dimethyl-p-(m-tolylazo) Aniline, 2,4-Dinitrophenol, Methyl Yellow (N,N-Dimethyl-p-phenylazoaniline), 4,4′-bis(2-amino-1-naphthylazo)2,2′-stilbenedisulfonic acid, potassium salt of tetrabromophenolphthalein ethyl ester, Bromophenol blue, Congo red, Methyl Orange, Methyl orange xylene cyanol solution, Ethyl orange, 2-((p-(dimethylamino)phenyl)azo)pyridine,4-(p-ethoxyphenylazo)-m-phenylenediamine monohydrochloride, Methyl Red, Lacmoid, Bromocresol Purple, Bromothymol Blue, Phenol Red, Metacresol Purple, Thymol Blue, Phenolphthalein, Thymolphthalein, Alizarin Yellow R, Carmine of Indigo, 2,5-Dinitrophenol, Bromocresol Green, Chlorophenol Red, Bromophenol Red, Neutral Red, Rosolic Acid, Cresol Red, o-cresolphthalein, tropaeolin o, 4-nitrophenol, anthocyanins, ferroin, n-phenylanthranilic Acid, Resazurin, fast green, yellow twilight, bright blue, bordeaux, tartasin, red 40, erythrosine, anthocyanin, curcumin, cochineal carmine, saffron, azorubine, capsanthin, carmine hydro, indigotine, pinachrome, ponseau 4R, Resorcinmalein, rodol green, riboflavin, beet red, heptamethoxy red, hexametoxy red, propyl red, beta carotene, and mixtures thereof.

Representative, but non-limiting, examples of alcohols used in step i) of route (a) may include ethanol, 1-propanol, 2-propanol, 1-butanol, 2-butanol, 1-pentanol, 2-pentanol, 1-hexanol, 2-hexanol, and mixtures thereof.

Representative but non-limiting examples of the non-volatile alkaline compounds used in step i) of route (a) may include alkaline metal bases such as lithium hydroxide, sodium hydroxide, potassium hydroxide, or organosilane bases such as aminopropyltriethoxysilane or aminopropyltrimethoxysilane, or mixtures thereof.

In one or more embodiments, the molar ratio of the indicator (or mixtures of indicators) to the alkaline compound may range from a lower limit or any of 1:20, 1:40, or 1:60, to an upper limit of any of 1:100, 1:150, or 1:200, where any lower limit can be used in combination with any upper limit.

Step ii) of the indicator encapsulation route (a) may include adding a volatile alkaline compound, such as ammonium hydroxide to the solution obtained in i). The molar concentration of a volatile alkaline compound in the alcohol solution used in step ii) of the indicator encapsulation route (a) may have a lower limit of any of 0.01, 0.1, 0.5, 1.0, or 2.0 mol/L to an upper limit of any of 7, 8, 9, or 10 mol/L, where any lower limit can be used in combination with any upper limit.

Step iii) of the indicator encapsulation route (a) may include adding a tetraalkylorthosilicate to the solution obtained in ii), resulting in the chemical reaction of silica formation and in the encapsulation of the indicator.

Representative but non-limiting examples of tetralkylorthosilicate compounds used in step iii) of route (a) may include tetramethylorthosilicate (TMOS), tetraethylorthosilicate (TEOS), tetrapropylortosilicate (TPOS), tetrabutylorthosilicate (TBOS) and/or a mixture thereof.

In one or more embodiments, the ratio between the mass of indicator (g) and the volume (L) of tetralkylorthosilicate used in step iii) of route (a) may have a lower limit of any of 1, 2, 5, or 10 g/L and an upper limit of any of 20, 30, or 40 g/L, where any lower limit can be used in combination with any upper limit. Further, the stirring speed used in step iii) of route (a) may be maintained between 50 and 5000 rpm. In one or more embodiments, the reaction time of step iii) of route (a) may have a lower limit of any of 0.1, 0.2, or 0.3 h to an upper limit of any of 0.6, 2.0, 5.0, or 10 h.

Step iv) of the indicator encapsulation route (a) may include removing solvent from the product from the reaction obtained in iii).

Methods for solvent removal in step iv) of process (a) include but are not limited to: nitrogen flow drying, vacuum drying, evaporation, filtration and drying with supercritical fluid.

Step v) of the indicator encapsulation route (a) may be optional and may include washing the product obtained in iv) with an alcohol and drying it.

Representative but non-limiting examples of the alcohol used in step v) of route (a) are may include ethanol, 1-propanol, 2-propanol, 1-butanol, 2-butanol, 1-pentanol, 2-pentanol, 1-hexanol, 2-hexanol, and mixtures thereof.

The drying methods in step v) of route (a) may include but are not limited to: nitrogen flow drying, vacuum drying, evaporation, filtration and drying with supercritical fluid.

The encapsulation process of the indicator via a two-step acid/basic catalysis sol-gel, also referred to as route (b) may include the following steps: i) Adding the acid-base indicator or mixture of acid-base indicators to an acidified alcoholic solution; ii) Adding and reacting a tetraalkylorthosilicate in the solution obtained in i); iii) Precipitating the silica containing the encapsulated indicator by adding a non-volatile alkaline compound to the solution obtained in ii); iv) Removing the solvent of the product from the reaction obtained in iii); v) Optionally, washing the product obtained in iv) with an alcohol and drying it; vi) Optionally, washing the product obtained in v) with an alkaline compound and drying it.

Step i) of the indicator encapsulation route (b) may include adding the acid-base indicator or a mixture of the acid-base indicators to an acidified alcoholic solution.

Representative but non-limiting examples of the acid-base indicator used in step i) of route (b) include: Methyl Violet, Crystal Violet, Ethyl Violet, Malachite Green, 2-((p-(dimethylamino) phenyl) azo) pyridine, Quinaldine Red, para-methyl Red, Litmus, Metanil Yellow, 4-phenylazodiphenylamine, Thymol blue, m-Cresol Purple, Tropaeolin 00, 4-o-tolylazo-o-toluidine, Erythrosine sodium salt, Benzopurpurin 4B, N,N′-dimethyl-p-(m-tolylazo) Aniline, 2,4-Dinitrophenol, Methyl Yellow (N,N-Dimethyl-p-phenylazoaniline), 4,4′-bis(2-amino-1-naphthylazo)2,2′-stilbenedisulfonic acid, potassium salt of tetrabromophenolphthalein ethyl ester, Bromophenol blue, Congo red, Methyl Orange, Methyl orange xylene cyanol solution, Ethyl orange, 2-((p-(dimethylamino)phenyl)azo)pyridine,4-(p-ethoxyphenylazo)-m-phenyl enediamine monohydrochloride, Methyl Red, Lacmoid, Bromocresol Purple, Bromothymol Blue, Phenol Red, Metacresol Purple, Thymol Blue, Phenolphthalein, Thymolphthalein, Alizarin Yellow R, Carmine of Indigo, 2,5-Dinitrophenol, Bromocresol Green, Chlorophenol Red, Bromophenol Red, Neutral Red, Rosolic Acid, Cresol Red, o-cresolphthalein, tropaeolin o, 4-nitrophenol, anthocyanins, ferroin, n-phenylanthranilic Acid, Resazurin, fast green, yellow twilight, bright blue, bordeaux, tartasin, red 40, erythrosine, anthocyanin, curcumin, cochineal carmine, saffron, azorubine, capsanthin, carmine hydro, indigotine, pinachrome, ponseau 4R, Resorcinmalein, rodol green, riboflavin, beet red, heptamethoxy red, hexametoxy red, propyl red, beta carotene, and mixtures thereof.

Representative but non-limiting examples of alcohols used in step i) of route (b) may include ethanol, 1-propanol, 2-propanol, 1-butanol, 2-butanol, 1-pentanol, 2-pentanol, 1-hexanol, 2-hexanol, and mixtures thereof.

Representative but non-limiting examples of acids which can be used to acidify the alcoholic solution in step i) of route (b) may include hydrochloric acid, nitric acid, sulfuric acid, acetic acid, oxalic acid and citric acid.

In one or more embodiments, the acidified alcoholic solution of step i) of route (b) may have an acid concentration having a lower limit of any of 0.000001, 0.0001, 0.01, or 0.1 mol/L to an upper limit of any of 1, 2, or 3 mol/L.

Step ii) of the indicator encapsulating route (b) may include adding and reacting a tetraalkylorthosilicate in the solution obtained in i).

Representative but non-limiting examples of tetralkylorthosilicate compounds used in step (ii) of route (b) may include tetramethylorthosilicate (TMOS), tetraethylorthosilicate (TEOS), tetrapropylorthoosilicate (TPOS), tetrabutylorthosilicate (TBOS) and/or a mixture thereof. The ratio between the mass of indicator (g) and the volume (L) of tetralkylorthosilicate used in step ii) of route (b) may have a lower limit of any of 1, 2, 5, or 10 g/L and an upper limit of any of 20, 30, or 40 g/L, where any lower limit can be used in combination with any upper limit. The reaction time of step ii) of route (b) may have a lower limit of any of 0.01, 0.1, 1, 2, or 4 hrs to an upper limit of any of 12, 24, 36, or 48 hrs.

Step iii) of the indicator encapsulation route (b) may include precipitating the encapsulated indicator containing silica by adding an alkaline compound to the solution obtained in ii).

Representative but not limiting examples of alkaline compounds (which may be volatile or non-volatile) used in step iii) of route (b) are: alkaline metal bases such as lithium hydroxide, sodium hydroxide, potassium hydroxide, or ammonium hydroxide, or organosilane bases such as aminopropyltriethoxysilane or aminopropyltrimethoxysilane, or mixtures thereof.

In one or more embodiments, the molar ratio of alkaline compound used in step iii) of route (b) and tetralkylorthosilicate may have a lower limit of any of 0.01:1.0, 0.1:1.0, 0.5:1.0, and 1.0:1.0 and an upper limit of any of 3.0:1.0, 4.0:1.0, or 5.0:1.0, where any lower limit can be used in combination with any upper limit.

Step iv) of the indicator encapsulation route (b) may include removing the solvent from the reaction product obtained in iii). Methods for solvent removal in step iv) of route (b) include but are not limited to: nitrogen flow drying, vacuum drying, evaporation, filtration and drying with supercritical fluid.

Step v) of the indicator encapsulation route (b) may be optional and may include washing the product obtained in iv) with an alcohol and drying it.

Non-limiting examples of the alcohol used in step v) of route (b) may include ethanol, 1-propanol, 2-propanol, 1-butanol, 2-butanol, 1-pentanol, 2-pentanol, 1-hexanol, 2-hexanol, and mixtures thereof.

The drying methods in step v) of route (b) may include but are not limited to:

nitrogen flow drying, vacuum drying, evaporation, filtration and drying with supercritical fluid.

Step vi) of the indicator encapsulation route (b) may be optional and may include washing the product obtained in v) with an alkaline compound and drying it.

Representative but not limiting examples of the alkaline compounds used in step vi) of route (b) may include lithium hydroxide, sodium hydroxide, potassium hydroxide, aminopropyltriethoxysilane, aminopropyltrimethoxysilane or mixtures thereof.

The concentration of the alkaline compound used in step vi) of route (b) may have a lower limit of any of 0.01, 0.1, 0.5, 1.0, or 2.0 mol/L to an upper limit of any of 7, 8, 9, or 10 mol/L, where any lower limit can be used in combination with any upper limit.

The alkaline compound used in step vi) of route (b) may be added in an equimolar amount relative to the tetralkylorthosilicate.

The drying methods in step vi) of route (b) may include include but are not limited to: nitrogen flow drying, vacuum drying, evaporation, filtration and drying with supercritical fluid.

In one or more embodiments, the indicator may be added relative to the same weight of encapsulant precursor that may have a mole percent (mol %) that varies from 0.001 mol % to 10 mol % of indicator per mol of encapsulant precursor.

Intelligent polymer compositions in accordance may contain a concentration of indicator at a percent by weight (wt %) of the polymer composition that may range from a lower limit selected from any of 0.005 wt %, 0.1 wt %, 1 wt % and 5 wt % to an upper limit selected from any of 10 wt %, 20 wt %, 30 wt % and 40 wt %, where any lower limit can be combined with any upper limit.

Silica Capsules Characteristics

One or more embodiments of the present disclosure may be directed to silica capsules, which may be prepared by routes (a) or (b), described above. These silica capsules contain an acid-base indicator converted by a non-volatile alkaline compound, wherein the molecules of that indicator are distributed both on the surface and in the bulk of the silica network forming the capsule. By virtue of the conversion, the silica capsules of the present disclosure may contain in its composition an alkaline compound from the conversion of the acid-base indicator to its basic form. In one or more embodiments, the molar proportion between the acid-base indicator and the alkaline compound in the silica capsules of the present disclosure may have a lower limit of any of 1:20, 1:40, or 1:60 and an upper limit of any of 1:100, 1:150, or 1:200, where any lower limit can be used in combination with any upper limit.

In one or more embodiments, the amount of acid-base indicator encapsulated within the silica capsules of the present disclosure may have a lower limit of any of 1000, 2000, or 4000 ppm, and an upper limit of any of 30,000, 40,000, or 50,000 ppm, where any lower limit can be used in combination with any upper limit.

In one or more embodiments, the silica capsules of the present disclosure may have a spheroidal morphology with average particle size, measured by FEG-SEM, having a lower limit of any of 0.1, 0.5, or 1.0 micrometers, and an upper limit of any of 10, 20, or 50 micrometers, where any lower limit can be used in combination with any upper limit.

In one or more embodiments, the relative percentage of six-fold siloxane rings (SiO)₆ to the total siloxane rings (considering (SiO)₄+(SiO)₆) measured by ATR-FTIR, in the silica capsules of the present disclosure may have a lower limit of any of 60, 70, or 80%, and an upper limit of any of 85, 90, 94, or 96%.

In one or more embodiments, the specific surface area (SBET) of the silica capsules of the present disclosure may have a lower limit of any of 0.5, 1.0, or 10.0 m²/g and an upper limit of any of 100, 200, or 300 m²/g, where any lower limit can be used in combination with any upper limit.

In one or more embodiments, the average pore diameter (Pd BJH) of the silica capsules of the present disclosure may have a lower limit of any of 50, 100, or 150 Å and an upper limit of any of 300, 400, or 500 Å, where any lower limit can be used in combination with any upper limit.

In one or more embodiments, the BET constant of the silica capsules of the present disclosure may have a lower limit of any of 10, 25, or 50, and an upper limit of any of 300, 400, or 500, where any lower limit can be used in combination with any upper limit.

Matrix Polymer

Intelligent polymer compositions in accordance with the present disclosure may be prepared with a matrix polymer that forms a semi-permeable barrier between a packaged material and one or more embedded indicators (encapsulated in one or more embodiments, as described herein). Matrix polymers may include homopolymers, copolymers, heterophasic polymers and polymers blends. In one or more embodiments, the matrix polymer may include polar polymers that may decrease leaching of an encapsulated indicator. In one or more embodiments, the matrix polymer may include non-polar polymers. Further, in one or more embodiments, the matrix polymer may include both polar and non-polar polymers.

In one or more embodiments, the content of polar polymer in the matrix polymer composition may range from a lower limit of any of 0, 5, 10, 20 or 30 wt % to an upper limit of any of 40, 60, 80 or 100 wt % of the polymer composition. The polar polymer content in the matrix may vary depending on the application and its color change requirements (e.g. the presence of polar polymer may not be required when the application is for indication in highly concentrated medium).

Matrix polymers in accordance with the present disclosure may include polyolefins, ethylene vinyl acetate (EVA), ethylene vinyl acetate rubber, polyamides, polyesters, polyacrylic acids, polymers of acrylonitrile, polymethylmethacrylate and derivatives, poly(vinyl acetate), cellulose acetate; polyethylene oxide, poly (vinyl butyl ether), phenolic resins, epoxy resins, polyacrylamides and copolymers of acrylamides, ethylene vinyl alcohol (EVOH), polystyrenes, styrenic block copolymers such as styrene-ethylene/butylene-styrene (SEBS), terpolymers and mixtures thereof. Matrix polymers may include polymers generated from petroleum-based monomers and/or biobased monomers.

Polyolefin

Matrix polymer compositions in accordance with the present disclosure may include polyolefins. In one or more embodiments, polyolefins include polymers produced from unsaturated monomers (olefins or “alkenes”) with the general chemical formula of CₙH₂ₙ. In some embodiments, polyolefins may include ethylene homopolymers, copolymers of ethylene and one or more C3-C20 alpha-olefins, propylene homopolymers, heterophasic propylene polymers, copolymers of propylene and one or more comonomers selected from ethylene and C4-C20 alpha-olefins, olefin terpolymers and higher order polymers, and blends obtained from the mixture of one or more of these polymers and/or copolymers. In some embodiments, polyolefins may be generated with a suitable catalyst such as Ziegler-Natta, metallocene, post-metallocene, and chromium catalysts.

In one or more embodiments, polyolefins are selected from polyethylene, polypropylene and combinations thereof. In one or more embodiments, polyethylenes may include polyethylenes having a monomodal, bimodal, trimodal or multimodal molecular weight distribution.

Polyolefins may be monomodal or multimodal compositions. As used herein, “modality” of a polymer may refer to the shape of a molecular weight distribution for a population of polymer molecules in a polymer sample. The rate of chain propagation in a polymerization is not uniform and, as a result, distributions of molecular weights will exist in a polymer sample obtained from a reactor. For polymer samples prepared by combining multiple polymer samples, or for samples originating from a multi-step synthesis, the different polymer fractions will have distinct molecular weight distributions, which will be present as multiple maxima or a broadened peak. As used herein “multimodal” refers to a polyolefin composition exhibiting two or more distinct peaks within the molecular weight distribution.

In one or more embodiments, multimodal polyolefin compositions may include a low molecular weight (LMW) fraction and a high molecular weight (HMW) fraction. In some embodiments, the ratio of the LMW fraction and the HMW fraction may range from a lower limit selected from any of 20:80, 40:60, and 50:50, to an upper limit selected from any of 55:45, 60:40, and 80:20, where any lower limit can be combined with any upper limit.

In one or more embodiments, polyolefins include polyethylene, including ethylene homopolymer and/or ethylene copolymers with one or more C3-C20 alpha-olefins, and combinations thereof.

In one or more embodiments, polyethylene may include polyethylene generated from petroleum based monomers and/or biobased monomers, such as ethylene obtained by the dehydration of biobased alcohols obtained from sugarcane. Commercial examples of biobased polyethylenes are the “I'm Green”™ line of bio-polyethylenes from Braskem S.A.

Ethylene Vinyl Acetate Copolymer (EVA)

Matrix polymer compositions in accordance with the present disclosure may include EVA copolymers. EVA copolymers are prepared by the copolymerization of ethylene and vinyl acetate. In one or more embodiments, the EVA copolymer can be derived from fossil or renewable sources such as biobased EVA. Biobased EVA is an EVA wherein at least one of ethylene and/or vinyl acetate monomers are derived from renewable sources, such as ethylene derived from biobased ethanol. In one or more embodiments, the vinyl acetate content of the EVA copolymer may range from a lower limit of any of 8, 10, 12, 16, or 20, to an upper limit of any of 20, 40, 60, or 80% wt, where any lower limit can be used in combination with any upper limit. Further, in one or more embodiments, the EVA copolymer may have a melt flow index (MFI), measured according to ASTM D1238 with a load of 2.16 kg at 190° C., may have a lower limit of any of 0.1, 0.5, 1.0, 2.0, or 5.0 g/10 min and an upper limit of any of 25, 50, 75, 100, 125, or 150 g/10 min.

Ethylene Vinyl Acetate Rubber

Polymer compositions in accordance to the present disclosure may include an ethylene vinyl acetate (EVA) rubber resin prepared from of (A) EVA copolymer, (B) ethylene alpha-olefin copolymer, (C) polyorganosiloxane, (D) plasticizer, and (E) rubber. In one or more embodiments, the EVA rubber composition may include components generated from petroleum based monomers and/or biobased monomers, including the EVA copolymer and the ethylene alpha-olefin copolymer. EVA rubber compositions are prepared as disclosed in the Brazilian patent BR102012025160-4 and US2019/0315949, both of which are incorporated herein by reference in their entirety. The major components of the EVA rubber of the present disclosure are detailed below. In one or more embodiments, EVA rubber resins may be selected from commercially available resins by Braskem such as VA4018R, VA1518A, VA8010SUV, SVT2145R, and combinations thereof.

(A) EVA Copolymer

EVA rubber compositions in accordance may incorporate one or more EVA copolymers prepared by the copolymerization of ethylene and vinyl acetate. In one or more embodiments, the EVA copolymer can be derived from fossil or renewable sources such as biobased EVA. Biobased EVA is an EVA wherein at least one of ethylene and/or vinyl acetate monomers are derived from renewable sources, such as ethylene derived from biobased ethanol. It is envisioned that the EVA copolymer present in the EVA rubber composition may include those discussed above.

EVA rubber compositions in accordance with the present disclosure may contain an ethylene vinyl acetate copolymer at a percent by weight (wt %) of the composition that ranges from a lower limit of 20 wt %, 30 wt %, 40 wt %, or 50 wt %, to an upper limit of 60 wt %, 70 wt %, 80 wt %, or 90 wt %, where any lower limit may be paired with any upper limit.

(B) Ethylene Alpha-Olefin Copolymer

EVA rubber compositions in accordance may incorporate one or more copolymers prepared from the polymerization of ethylene and a C3 to C20 alpha-olefin. EVA rubber compositions in accordance with the present disclosure may contain an ethylene alpha-olefin copolymer at a percent by weight (wt %) of the composition that ranges from a lower limit of 5 wt % or 10 wt %, to an upper limit of 30 wt % or 60 wt %, where any lower limit may be paired with any upper limit.

(C) Polyorganosiloxane

EVA rubber compositions in accordance may incorporate a polyorganosiloxane. In one or more embodiments, suitable polyorganosiloxanes include a linear chain, branched, or three-dimensional structure, wherein the side groups can include one or more of methyl, ethyl, propyl groups, vinyl, phenyl, hydrogen, amino, epoxy, or halogen substituents. The terminal groups of the polyorganosiloxane may include hydroxyl groups, alkoxy groups, trimethylsilyl, dimethyldiphenylsilyl, and the like. Polyorganosiloxanes in accordance with the present disclosure may include one or more of dimethylpolysiloxane, methylpolysiloxane, and the like.

EVA rubber compositions in accordance with the present disclosure may contain a polyorganosiloxane at a percent by weight (wt %) of the composition that ranges from a lower limit of 0.1 wt % or 0.5 wt %, to an upper limit of 5 wt % or 10 wt %, where any lower limit may be paired with any upper limit.

(D) Plasticizer

EVA rubber compositions in accordance may incorporate a plasticizer to improve the processability and adjust the hardness of the EVA rubber. Plasticizers in accordance with the present disclosure may include one or more of bis(2-ethylhexyl) phthalate (DEHP), di-isononyl phthalate (DINP), bis (n-butyl) phthalate (DNBP), butyl benzyl phthalate (BZP), di-isodecyl phthalate (DIDP), di-n-octyl phthalate (DOP or DNOP), di-o-octyl phthalate (DIOP), diethyl phthalate (DEP), di-isobutyl phthalate (DIBP), di-n-hexyl phthalate, tri-methyl trimellitate (TMTM), tri-(2-ethylhexyl) trimellitate (TEHTM-MG), tri-(n-octyl, n-decyl) trimellitate, tri-(heptyl, nonyl) trimellitate, n-octyl trimellitate, bis (2-ethylhexyl) adipate (DEHA), dimethyl adipate (DMD), mono-methyl adipate (MMAD), dioctyl adipate (DOA)), dibutyl sebacate (DBS), polyesters of adipic acid such as VIERNOL, dibutyl maleate (DBM), di-isobutyl maleate (DIBM), benzoates, epoxidized soybean oils, n-ethyl toluene sulfonamide, n-(2-hydroxypropyl) benzene sulfonamide, n-(n-butyl) benzene sulfonamide, tricresyl phosphate (TCP), tributyl phosphate (TBP), glycols/polyesters, triethylene glycol dihexanoate, 3 gh), tetraethylene glycol di-heptanoate, polybutene, acetylated monoglycerides; alkyl citrates, triethyl citrate (TEC), acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trihexyl o-butyryl citrate, trimethyl citrate, alkyl sulfonic acid phenyl ester, 2-cyclohexane dicarboxylic acid di-isononyl ester, nitroglycerin, butanetriol trinitrate, dinitrotoluene, trimethylolethane trinitrate, diethylene glycol dinitrate, triethylene glycol dinitrate, bis (2,2-dinitropropyl) formal, bis (2,2-dinitropropyl) acetal, 2,2,2-trinitroethyl 2-nitroxyethyl ether, mineral oils, among other plasticizers and polymeric plasticizers.

EVA rubber compositions in accordance with the present disclosure may contain a plasticizer at a percent by weight (wt %) of the composition that ranges from a lower limit of 0.5 wt % or 2 wt %, to an upper limit of 10 wt % or 20 wt %, where any lower limit may be paired with any upper limit.

(E) Rubber

EVA rubber compositions in accordance may incorporate a rubber component to increase the rubbery touch and increase the coefficient of friction, depending on the end application. Rubbers in accordance with the present disclosure may include one or more of natural rubber, poly-isoprene (IR), styrene and butadiene rubber (SBR), polybutadiene, nitrile rubber (NBR); polyolefin rubbers such as ethylene-propylene rubbers (EPDM, EPM), and the like, acrylic rubbers, halogen rubbers such as halogenated butyl rubbers including brominated butyl rubber and chlorinated butyl rubber, brominated isotubylene, polychloroprene, and the like; silicone rubbers such as methylvinyl silicone rubber, dimethyl silicone rubber, and the like, sulfur-containing rubbers such as polysulfidic rubber; fluorinated rubbers; thermoplastic rubbers such as elastomers based on styrene, butadiene, isoprene, ethylene and propylene, styrene-isoprene-styrene (SIS), styrene-ethylene-butylene-styrene (SEBS), styrene-butylene-styrene (SBS), and the like, ester-based elastomers, elastomeric polyurethane, elastomeric polyamide, and the like.

EVA rubber compositions in accordance with the present disclosure may contain a rubber at a percent by weight (wt %) of the composition that ranges from a lower limit of 0.5 wt % or 1 wt %, to an upper limit of 20 wt % or 40 wt %, where any lower limit may be paired with any upper limit.

Polymeric Matrix Stabilizer

In one or more embodiments, intelligent polymer compositions may include a matrix stabilizer that modifies the acidity/alkalinity of the system (matrix and indicator), preventing reversion of the indicator following a color change upon reaction with stimuli resulting from processing byproducts (e.g. acetic acid from EVA). In some embodiments, matrix stabilizers may include stearate salts such as sodium stearate and calcium stearate, magnesium oxide, calcium carbonate, talc, and the like. In one or more embodiments, an acidity/alkalinity modifier may be added to an intelligent polymer composition at a concentration having a lower limit selected from any of 100 ppm, 300 ppm, and 600 ppm, to an upper limit selected from any of 9,500 ppm, 10,000 ppm, and 20,000 ppm, where any lower limit may be combined with any upper limit.

Additives

Intelligent polymer compositions in accordance with the present disclosure may incoporate one or more functional additives, including stabilizers such as distearyl pentaerythritol phosphite; metal compounds such as zinc 2-ethylhexanoate; epoxy compounds such as epoxidized soybean oil and epoxidized linseed oil; nitrogen compounds such as melamine; phosphorus compounds such as tris(nonylphenyl)phosphite; UV absorbers such as Hindered Amine Light Stabilizer compounds, benzophenone compounds and benzotriazole compounds; antioxidants; silicone oils; fillers such as clay, kaolin, talc, hydrotalcite, mica, zeolite, perlite, diatomaceous earth, calcium carbonate, glass (beads or fibers), and wood flour; foaming agents; foaming aids; crosslinking agents; crosslinking accelerators; flame retardants; dispersants; and processing aids such as resin additives. Other additives may include plasticizers, acid scavengers, stearates, antimicrobials, antioxidants, flame retardants, light stabilizers, antistatic agents, colorants, pigments, perfumes, chlorine scavengers, and the like.

Formulation of Intelligent Polymer Compositions

Intelligent polymer compositions in accordance with the present disclosure may be prepared by extrusion using standard processing parameters for polyolefins, such as temperature profile and screw profile (for example, twin-screw, with the use of distributive and dispersive mixing elements). In addition, batch mixers such as mixing chambers, banbury mixers, and the like, using standard processing conditions and temperature profile for polyolefins may be used. Further, it is also understood that one or more subsequent steps may be used in order to produce the actual part, using the same equipment and very similar processing parameters (e.g. extrusion blow molding (EBM), injection stretching blow molding (ISBM), injection molding, thermoforming, film extrusion, blown film extrusion, sheet extrusion, additive manufacturing, and the like).

In one or more embodiments, polymer components may be combined in a single step or as a series of combination steps. For example, a subset of intelligent polymer composition components may be combined concurrently or separately in an extruder as a masterbatch or a final composition. It is also envisioned, for example, that most components of the formulation may be added together, with the polymeric matrix subsequently being added.

In one or more embodiments, polymer compositions in accordance with the present disclosure may be formulated as a “masterbatch” in which the polymer composition contains concentrations of indicator that are high relative to the indicator concentration in a final polymer blend for manufacture or use. For example, a masterbatch stock may be formulated for storage or transport and, when desired, be combined with additional polyolefin or other matrix polymers in order to produce a final polymer composition having concentration of constituent components that provides indicator, physical, and chemical properties tailored to a selected end-use. Further, in one or more embodiments, a masterbatch can be made with the indicator and one or more additives in a first matrix polymer compound, which is subsequently diluted afterwards in a second matrix polymer, which may be the same or different matrix polymer. In using such a masterbatch formulation, the masterbatch may be formulated and then diluted so that the final formulation possesses adequate concentration of indicator and one or more additives.

In one or more embodiments, a masterbatch polymer composition may contain a percent by weight of the total composition (wt %) of indicator (which may, for example, be an encapsulated indicator, i.e., capsules) s ranging from a lower limit selected from one of 5, 7, 9 or 10 wt % to an upper limit selected from one of 15, 18 or 20 wt %, where any lower limit can be used with any upper limit. Similarly, a masterbatch may include a matrix polymer (preferably, polar polymer) in an amount that ranges from a lower limit selected from 80, 82, or 85 wt % to an upper limit selected from one of 90, 91, 93 or 95 wt %, where any lower limit can be used with any upper limit.

As noted, in the masterbatch composition, the polymer composition contains concentrations of indicator that are high relative to the indicator concentration in a final polymer blend for manufacture or use. Thus, prior to use to form a manufactured article, the masterbatch composition may be combined with an additional quantity of matrix polymer to arrive at a indicator concentration in the final composition that is lower than the masterbatch concentration. Further, when it is desirable to form a manufactured article without use of a masterbatch composition, the lower quantities of indicator and higher quantities of matrix polymer may be used, to arrive at the concentrations described above.

As mentioned above, in one or more embodiments, intelligent polymer compositions of the present disclosure may be processed via extrusion. In particular, processing via twin screw extruder may have good dispersion and distribution capabilities (to disperse the indicator into the polymer matrix) to provide a homogeneous and time-phased color change. Depending on the type of polymer matrix being used and physical aspect of the feeding material (e.g. powder, pellets, etc.), set temperature, screw profile, throughput rate, screw rotation, and residence time may be selected. In embodiments using polar blend components (e.g., EVA), a melt temperature below 210° C., preferentially below 200° C., may be selected to minimize or reduce thermal degradation and release of acid compounds that might interact with the indicator. Further, in addition to set temperatures, screw speeds may be controlled in order to avoid excessive heat generated by shear. An example of a temperature profile range for an HDPE and EVA blend in an intelligent composition is as shown in Table 2, where the lower part of the range would be more adequate for a higher MFR matrix.

TABLE 2

| Zone | Temperature (° C.) - Condition 1 |
|---|---|
| 1 | 60-100 |
| 2 | 120-150 |
| 3 | 135-170 |
| 4 | 150-175 |
| 5 | 160-180 |
| 6 | 160-185 |
| 7 | 160-185 |

Example processing conditions for a lab scale TSE (Twin Screw Extruder) may include: a throughput rate of 2-4 kg/h, screw speed 200-280 rpm, with a relatively high-shear screw profile, where the residence time would be in the range from 25 to 90 s. For example, an extrusion may use a Coperion ZSK-18 extruder.

When final processing uses extrusion blow molding, processing may similar to a regular polyolefin, however, melt temperatures may be below 200° C. Therefore, screw speed, which controls throughput rate of a certain machine, and also its profile and shear level, may be considered for each specific system (extruder+blowing unit), in order to avoid thermomechanical degradation of the blend polar component (e.g., EVA). An example of blow molding parameters to an industrial EBM (Extrusion Blow Molding) machine TECHNE-5000, for small volume parts is shown in Table 3:

TABLE 3

| Parameters | Unit | Value |
|---|---|---|
| Z 10 | ° C. | 160 |
| Z 11 | ° C. | 170 |
| Z 12 | ° C. | 175 |
| Z 15 | ° C. | 180 |
| Z 16 | ° C. | 190 |
| Z 17 | ° C. | 190 |
| Z 61 | ° C. | 190 |
| Z81 | ° C. | 190 |
| Z 82 | ° C. | 190 |
| Z 101 | ° C. | 190 |
| Z 102 | ° C. | 190 |
| Mold | ° C. | 15 |
| Screw speed | rpm | 20 |
| Current (engine) | A | 73 |
| Blow pressure | bar | 2 |
| Support air | bar | 2 |
| Bottle (w/o. burr) | bar | 25.5 |
| Thickness (lateral) | g | 0.7 |
| Cooling time | s | 9 |
| Blow time | s | 9 |
| Cycle time | s | 13.85 |

Intelligent polymer compositions may be adapted for use in a number of polymer processes including extrusion, coextrusion, extrusion coating, extrusion lamination, blown film extrusion, cast film extrusion, injection molding, blow molding, injection-blow molding, rotomolding, pultrusion, compression molding, solution casting, thermoforming, and additive manufacturing.

Additive Manufacturing

One or more embodiments disclosed herein relate to packaging produced by various additive manufacturing (AM) techniques that incorporate intelligent polymer compositions capable of providing visual indicators of product quality in response to changes in packaged goods. Polymer compositions in accordance with the present disclosure may be used to generate 3D printed intelligent packaging containing color-based pH indicators capable of detecting pH changes in enclosed materials and foods associated with various forms of microbe-induced spoilage. As mentioned above, embodiments of packaging produced by additive manufacturing may include use of either or both of unencapsulated and encapsulated indicators. Thus, in such embodiments, the indicator (whether or not it is encapsulated) may be incorporated into an intelligent polymer composition, including the intelligent polymer compositions discussed above, for use in forming, for example, a packaging material manufactured by additive manufacturing.

With the use of AM techniques, packaging materials such as caps, lids, bottles, boxes, and the like, may be generated from intelligent polymer compositions. In one or more embodiments, packaging materials having components that include both standard polymers and intelligent polymer compositions may be constructed in a single manufacturing step. For example, intelligent polymer composition may be integrated into a 3D printing process to generate articles having a fraction of the structure that is intelligent, while the remainder of the article may be selected for structural and/or aesthetic properties. AM techniques may be used to produce simple packaging with intelligent functionality, while minimizing the costs of specialized materials and obviating the need for additional steps to install labels or sensing devices.

AM techniques in accordance with the present disclosure may include extrusion-based techniques such as fused deposition modeling (FDM) or freeforming, electro-photography (EP), jetting, selective heat sintering (SHS), selective laser melting (SLM), selective laser sintering (SLS), high speed sintering (HSS), selective absorbing sintering (SAS), selective inhibition sintering (SIS), powder/binder jetting, electron-beam melting, and stereolithographic processes. The aim in all these methods is the production of printed articles having the same density as the polymeric material from which the powder has been produced, without the presence of cavities and/or inclusions.

Intelligent polymer compositions may be adapted for use in various additive manufacturing processes. Additive manufacturing systems in accordance with the present disclosure include any system that prints, builds, or otherwise produces 3D parts and/or support structures. Additive manufacturing systems may be a stand-alone unit, a sub-unit of a larger system or production line, and/or may include other non-additive manufacturing features, such as subtractive-manufacturing features, pick-and-place features, two-dimensional printing features, and the like.

In one or more embodiments, additive manufacturing techniques may include material extrusion, material jetting, binder jetting, material jetting, vat photopolymerization, sheet lamination, powder bed fusion and directed energy deposition. The most widely used of these AM technologies is based on material extrusion. Generally, examples of commercially available additive manufacturing techniques include extrusion-based techniques such as fused deposition modeling (FDM) or freeforming, electro-photography (EP), jetting, selective heat sintering (SHS), selective laser melting (SLM), selective laser sintering (SLS), high speed sintering (HSS), selective absorbing sintering (SAS), selective inhibition sintering (SIS), powder/binder jetting, electron-beam melting, and stereolithographic processes.

For each of these techniques, the digital representation of the 3D part is initially sliced into multiple horizontal layers. For each sliced layer, a tool path is then generated, which provides instructions for the particular additive manufacturing system to print the given layer. Particular additive manufacturing techniques that may be particularly suitable for the present polymer compositions include, for example, fused deposition modeling, selective laser sintering, high speed sintering, material jetting, or plastic freeforming.

In an extrusion-based additive manufacturing system, a 3D part may be printed from a digital representation of the 3D part in a layer-by-layer manner by extruding a flowable part material. The part material is extruded through an extrusion tip carried by a print head of the system, and is deposited as a sequence of roads on a substrate in an x-y plane. The extruded part material fuses to previously deposited part material, and solidifies upon a drop in temperature. The position of the print head relative to the substrate is then incremented along a z-axis (perpendicular to the x-y plane), and the process is then repeated to form a 3D part resembling the digital representation.

For example, according to fused deposition modeling, a filament or granules formed from an intelligent polymer composition discussed above are heated and extruded through an extrusion head that deposits the molten plastic in X and Y coordinates, while the build table lowers the object layer by layer in the Z direction.

Plastic freeforming, such as that offered by ARBURG GmbH and Co KG (Lossburg, Germany), operates using standard granulated plastics that are melted such as in an injection molding process. A clocked nozzle that opens and closes (up to 100 times a second) builds the component layer-by-layer from miniscule plastic droplets. Further description about such technique may be found in U.S. Pat. No. 9,039,953, which is herein incorporated by reference in its entirety.

Selective laser sintering uses powdered material in the build area instead of liquid or molten resin. A laser is used to selectively sinter a layer of granules, which binds the material together to create a solid structure. When the object is fully formed, it's left to cool in the machine before being removed. In high speed sintering (HSS), manufacturing occurs by depositing a fine layer of polymeric powder, after which inkjet printheads deposit an infrared (IR) absorbing fluid (or toner powder) directly onto the powder surface where sintering is desired. The entire build area is then irradiated with an IR radiation source such as an infrared lamp, causing the printed fluid to absorb this energy and then melt and sinter the underlying powder. This process is then repeated layer by layer until the build is complete. While SLS and HSS are detailed as examples of powder bed fusion techniques, it is also envisioned that the intelligent polymer compositions may be adapted for use in other powder bed fusion techniques such as selective heat sintering (SHS), selective laser melting (SLM), selective absorbing sintering (SAS), and selective inhibition sintering (SIS).

Applications

Intelligent polymer compositions may be used in a number of fields as a visual indicator of changes such as pH temperature, humidity, time, and the presence of organic volatiles and/or oxygen. In one or more embodiments, intelligent polymer compositions may be applied in various forms of food packaging and packaging elements such as windows inserts, films, and the like, to communicate particular qualities of the food through color change in response to stimuli. In some embodiments, intelligent compositions may undergo a color change in response to pH changes induced by spoilage organisms, which indicates to a consumer the presence of food degradation.

In the following section, various possible embodiments of packaging materials in accordance with the present disclosure are discussed with reference to the figures.

Intelligent Cap

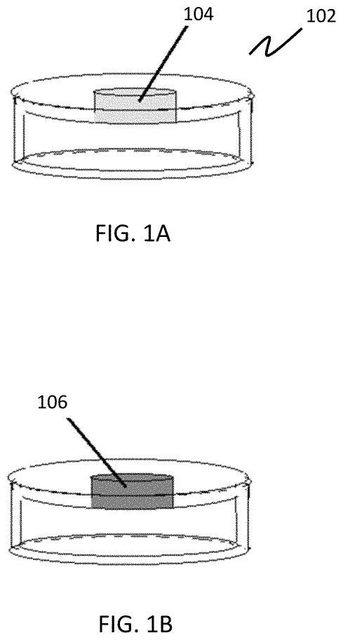

With particular respect to FIG. 1A, a cap 102 for a bottle or other container is constructed from a polymer and includes an intelligent polymer composition insert 104 formed by an intelligent polymer composition. When an indicator embedded in the intelligent polymer compositions 104 detects a change in pH or other appropriate stimuli for materials contained within the bottle, the insert 106 changes color to convey this information to a consumer as shown in FIG. 1B. In one or more embodiments, the intelligent composition may be in direct contact with an enclosed material, contact may be temporary through splashing, or contact may be indirect through vapors generated from a solid or liquid material.

Intelligent Packaging

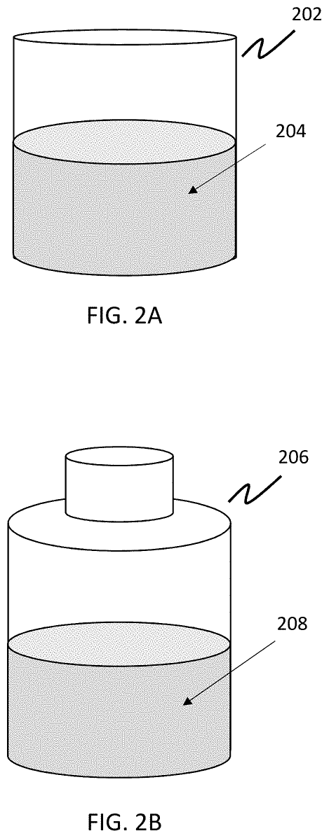

With particular respect to FIG. 2A, a bag constructed from an intelligent polymer composition 202 is shown having a reservoir for storing a material 204, such as a liquid or solid. When changes in material 204 are sufficient to trigger the indicator in the intelligent polymer composition 202, the packaging will undergo a visible change in color that alerts the consumer as to the change in material quality. The intelligent polymer composition may change in color entirely when the indicator is triggered, or the color change may be limited to the portion of the packaging contacting the material.

With particular respect to FIG. 2B, a design for a bottle constructed from an intelligent polymer composition 206 is shown having a reservoir for storing a material 204, such as a liquid or solid. When changes in material 204 are sufficient to trigger the indicator in the intelligent polymer composition 206, the packaging will undergo a visible change in color that alerts the consumer as to the change in material quality.

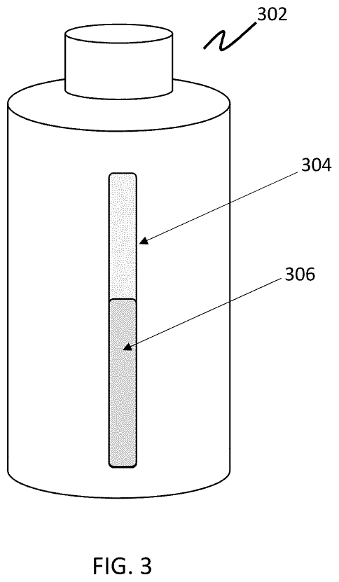

With particular respect to FIG. 3, a bottle 302 is constructed having an indicator window 304 constructed from an intelligent polymer composition. The window 304 may be clear or translucent, and may be used to visualize the level of a liquid or solid 306 contained within the bottle 302, in addition to functioning as a visual indicator of material quality. When changes in material 306 are sufficient to trigger the indicator in the intelligent polymer composition, the packaging will undergo a visible change in color that alerts the consumer as to the change in material quality.

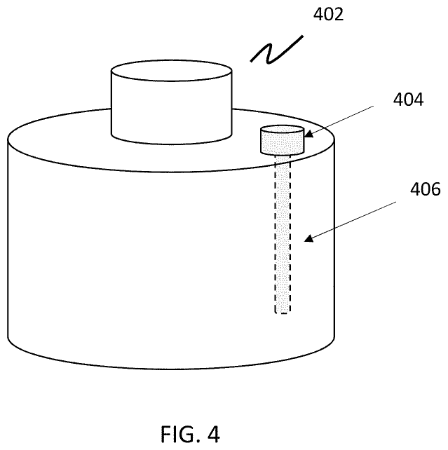

With particular respect to FIG. 4, a bottle 402 constructed from a polymer is shown containing an intelligent polymer composition insert 404 formed by an intelligent polymer composition. When an indicator embedded in the intelligent polymer compositions 104 detects a change in pH or other appropriate stimuli for materials contained within the bottle, the insert 106 changes color to convey this information to a consumer. In some embodiments, the insert may have an extended well 406 that contacts a fluid or solid within a reservoir within the bottle 402. The well 406 may be used in cases where contact with a material is desired as the material within the bottle 402 is depleted through use.

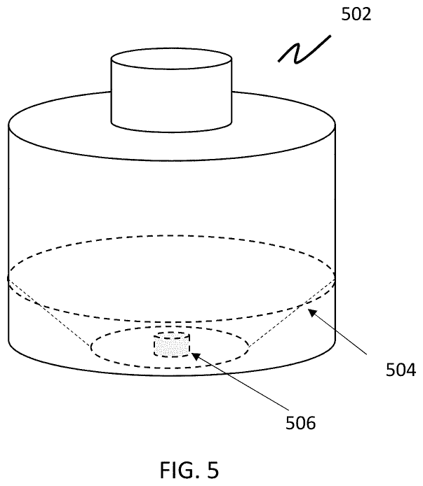

In the embodiment shown in FIG. 5, a bottle 502 constructed from a polymer is shown containing an intelligent polymer composition insert 506 formed by an intelligent polymer composition. When an indicator embedded in the intelligent polymer compositions 506 detects a change in pH or other appropriate stimuli for materials contained within the bottle, the insert 506 changes color to convey this information to a consumer. In one or more embodiments, the insert 506 is present on the underside of the package and contacts a material within a reservoir in bottle 502, allowing a consumer to verify the material quality by the status of the indicator in the insert 506 by inverting the package, despite the level of the material changing as it is used. In some embodiments, the bottom 504 of the bottle 502 may be shaped to direct materials to insert 506 to increase sensitivity of the insert as the level of material in the bottle 502 is depleted.

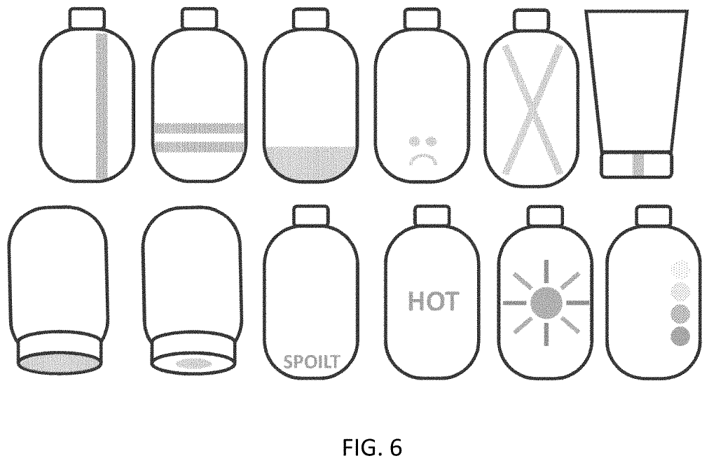

With particular respect to FIG. 6, a number of examples of alternative packaging configurations are shown. In the examples, gray shading or text indicates regions of the article printed with an intelligent polymer composition that may include one or more indicators responsive to various stimuli.

In one or more embodiments, intelligent polymer compositions in accordance with the present disclosure may be used in part or in whole of rigid and flexible containers, films, multilayer films, sheets, bottles, cups, containers, pouches, caps, labels, intelligent coatings, among others, as well as molded articles such as pipes, tanks, drums, water tanks, household appliances, packaging for healthcare products and medical devices, automotive applications, agrochemical applications, silo bags, smart windows, product labeling, geomembranes, housewares, mulching, and personal protective gear such as air filters and gas masks. Intelligent polymer compositions may also be used in leak detecting devices, such as those installed on gas and liquid pipelines.

In one or more embodiments, intelligent polymer compositions in accordance with the present disclosure may be used in blow molded bottles for food spoilage detection, such as bottles to detect liquid food, such as milk, spoilage detection.

In one of more embodiments, the intelligent polymer compositions in accordance with the present disclosure may be applied in multilayer packaging, such as multilayer bottles or containers. For example, in a packaging comprising two or more layers, the innermost layer in contact with the food may be formed by the intelligent polymer compositions in accordance with the present disclosure and the one or more outermost layers may be formed by other materials that have a transparency sufficient to allow the detection of color change.

Indicator Color Change Quantification

Intelligent polymer compositions in accordance with the present disclosure incorporate one or more indicators that respond to a predetermined reactive stimulus that initiates a color change in the polymer material that may be observable by eye and/or ultraviolet-visible spectrophotometer. While particular systems are described below with respect to the quantification of color change of intelligent polymer compositions, it is envisioned that any system capable of registering the change in color of an indicator or polymer composition containing an indicator may be used.

In one or more embodiments, the total color difference (TCD) exhibited by an indicator may be quantified by a TCD index such as a CieLAB color change index (ΔE) that uses L*, a*, b* values to describe the color of the polymer. AE is the difference in the color of the polymer before and after the contact with the external stimuli, and may be calculated in some embodiments according to Eq. (1) as described in Francis, F. J. 1983, Colorimetry of food, Peleg M. and Bagley E. B. (Eds.). Physical Properties of Foods, p. 105-123. Westport: AVI Publishing.

ΔE=[(ΔL*)²+(Δa*)²+(Δb*)²]^{1/2} (1)

In Eq. (1), L* refers to luminosity and a* and b*, are the chromatic coordinates. The parameter a, varies from green (negative values) to red (positive values). The parameter b, varies from blue (negative values) to yellow (positive values). Francis (1983) reported that TCD more than 5.0 could be easily detected by unaided eyes and TCD more than 12 presented a clearly different shade of color. The determination of ΔE values are known throughout the literature, and measurement systems such as the CieLAB color system are commercially available.

In one or more embodiments, intelligent polymer compositions in accordance with the present disclosure may exhibit a color change that is detectable by eye after exposure to the external stimuli, which corresponds to a ΔE of at least 8 or more. In some embodiments, intelligent polymer compositions in accordance with the present disclosure may exhibit a color change corresponding to a ΔE of at least 12 following exposure to the external stimuli.

### EXAMPLES

For a better understanding of the present disclosure several examples are presented, which should not be considered limitative of the scope and reach of the disclosure.

Color

The X-rite Colorimeter is used for colorimetric analysis of samples provides data based on the CIELab color space. The CIELab is a spherical system representative of color composed of three different axes: L* for the lightness from black (0) to white (100), a* from green (−) to red (+), and b* from blue (−) to yellow (+). Each color is represented by a point (L*, a*, b*) internal to the sphere. The colorimeter captures the color of the object and provides its numerical representation in the system CIELab.

Through the numerical representation of a color provided by the colorimeter, it is possible to use a CIELab converter to obtain the visual representation of the color. A website https://www.e-paint.co.uk/Convert lab.asp is used to obtain the color representations. Color data (L*, a*, b*) for a given sample may be collected from the colorimeter file, and transferred into the respective blanks for each axis in the above mentioned website, which may result in a conversion of the color data into the nearest standard color.

In the below data, the conversion of encapsulated indicators was tested with volatile acetic acid. The time to change color was registered by video record. The register of initial and final color was performed using the same methodology applied to the polymer composition. The capsules' color changes were measured into cubets used an X-rite Colorimeter, at room temperature (˜23° C.).

Quantification of the amount of encapsulated indicator by XRF

To quantify the amount of indicator (bromothymol blue) that was encapsulated in silica, a calibration curve was built using different known amounts of the indicator absorbed in silica synthesized without indicator (as a standard). The XRF allows the creation of an analysis method of quantification of bromine, and the results showed a linear correlation with the amount of indicator adsorbed in different standards. The size of silica synthesized with indicator or without indicator have the similar size (1-10 μm), and this size of silica capsules allows comparison of absorbed and encapsulated indicator by XRF.

The analyses were carried out in a WDXRF Bruker-AXS, model S4 Explorer, with 1 kW Rhodium tube, operating with tension of 50 kV and 20 mA. Scintillation detector of sodium iodide coupled to a photomultiplier tube, for heavy elements (Z>20). For the bromine reading in the equipment, 4 μm prolene membrane cups and 5-6 g of capsules were used.

Morphology and Size of Silica Capsules by FEG-SEM

FEG-SEM image of silica capsules and distribution of these silica capsules in the polymer composition were obtained using an FEG INSPECT F50 SEM from FEI company with 5 keV. The samples were metalized with gold or carbon using a Leica EM SCD500.

Structure of Silica Capsules by ATR-FTIR

FT-IR measurements were carried out using a Shimadzu spectrophotometer (IR Prestige 21), combining 32 scans at a 2 cm⁻¹ resolution. Samples were directly analyzed in absorbance mode using attenuated total reflectance infrared spectroscopy (Gladi-ATR-Pike Technologies).

Silica-based materials have a long-range amorphous structure, which results from a random network of elementary SiO₄ units, locally arranged into cyclosiloxanes, containing mostly four and six Si atoms. The relative proportions of these cyclic units can be obtained from the deconvolution of the νₐₛ(Si—O)Si—O—Si infrared band. The four components were previously assigned to the longitudinal and transverse optical doublets (LO/TO) in four-fold, (SiO)₄, and six-fold, (SiO)₆, siloxane rings in according with the literature (A. Fidalgo, R. Ciriminna, L. M. Ilharco, M. Pagliaro. Chem. Mater. 17 (2005) 66-86).

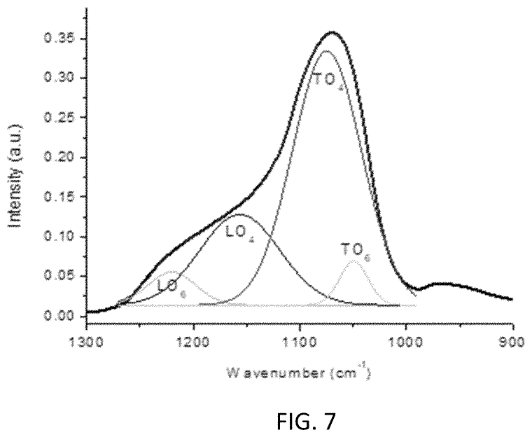

The typical ATR-FTIR spectrum of silica capsules, shown in FIG. 7, present a band at 1074-1098 cm⁻¹ attributed to the asymmetric stretching vibrations vₐₛ(Si—O) of the siloxane groups (Si—O—Si). An estimation of the percentage of (SiO)₆ can be obtained for each sample from the following ratio: (areas of LO₆+TO₆ components)/(total area of vₐₛ(Si—O) band).

BET N2 Adsorption/Desorption Experiments

N2 adsorption isotherms were performed on a Micromeritics Gemini 2375. The samples were pre-heated to 80° C. for 24 hours under a vacuum. The surface area (SBFT) and the BET constant (C), a measure of the interaction force between the adsorbate (nitrogen) molecules and the adsorbent, were determined using the Brunauer-Emmett-Teller (BET) method at 77.4 K in the range 0.01<P/Pₐₜₘ<0.35. The average diameter of the pores was calculated using the Barrett-Joyner-Halenda (BJH) standards and the method proposed by Halsey for consideration of the desorption isotherm. The pore volume was calculated using the t-plot and the isotherm pattern of Harkins and Jura. (present in LOWELL, S., et al. Characterization of Porous Solids and Powders: Surface Area, Pore Size and Density. Kluwer Academic Publishers, 2004).

Capsule A

Preparation of the Silica Capsule—Route (a) Molar Ratio 1 BTB: 40 KOH

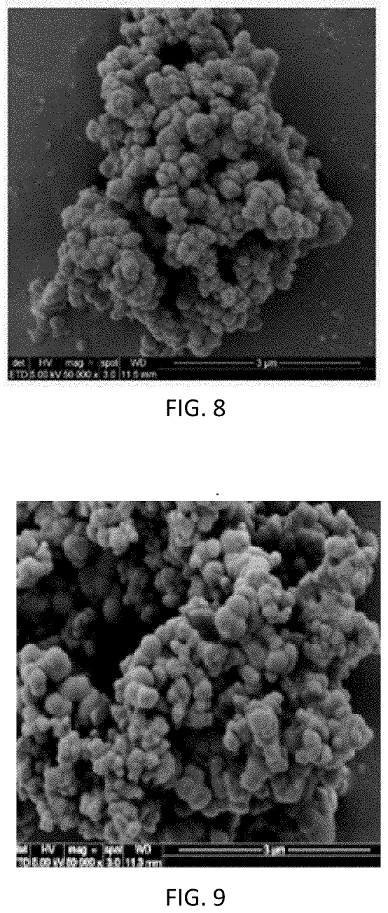

In a 1 L glass, 20 mL of ethanol PA, 3.4 mL of 10 mol/L potassium hydroxide solution (KOH) and 500 mg of bromothymol blue (BTB) were transferred. This reaction mixture was maintained under magnetic stirring for 2 min for conversion of BTB to BTB-converted. Then, to this solution, under magnetic stirring, 80 mL of ethanol PA was added, followed by 50 mL of concentrated ammonium hydroxide solution. Thereafter, 50 mL (280 mmol) of tetraethoxysilane (TEOS) (>98% purity) were added. The solution was kept under constant magnetic stirring for 30 min counted after the addition of TEOS, and then the silica was filtered, washed 1 time with 100 mL of ethanol, and oven dried at 100° C. for 8 h. An SEM of the resulting silica capsule (Capsule A) is shown in FIG. 8. Characterization of the Capsule A is provided in Table 4:

TABLE 4

| | | |
|---|---|---|
| Silica Particle Diameter | <1 | μm |
| BTB content by XRF | 14810 | ppm |

| | |
|---|---|
| % (SiO)₆ siloxane rings by ATR-FTIR | 77% |

Nitrogen Adsorption/Desorption Data

| | | |
|---|---|---|
| S_{BET} | 8.5 | m²/g |
| Pᵥ | 0.20 | cm³/g |
| P_{d} | 132 | Å |

| | |
|---|---|
| C | 40 |

Capsule B

Preparation of the Silica Capsule—Route (a) Molar Ratio 1 BTB: 80 KOH

In a 1 L glass, 20 mL of ethanol PA, 6.7 mL of 10 mol/L potassium hydroxide solution (KOH) and 500 mg of bromothymol blue (BTB) were transferred. This reaction mixture was maintained under magnetic stirring for 2 min for conversion of BTB to BTB-converted. Then, to this solution, under magnetic stirring, 80 mL of ethanol PA was added, followed by 50 mL of concentrated ammonium hydroxide solution. Thereafter, 50 mL (280 mmol) of tetraethoxysilane (TEOS) (>98% purity) were added. The solution was kept under constant magnetic stirring for 30 min counted after the addition of TEOS and then the silica was filtered, washed 1 time with 100 mL of ethanol, and oven dried at 100° C. for 8 h. An SEM of the resulting silica capsule (Capsule B) is shown in FIG. 9. Characterization of the Capsule B is provided in Table 5:

TABLE 5

| | | |
|---|---|---|
| Silica Particle Diameter | <1 | μm |
| BTB content by XRF | 17930 | ppm |

| | |
|---|---|
| % (SiO)₆ siloxane rings by ATR-FTIR | 82% |

Nitrogen Adsorption/Desorption Data

| | | |
|---|---|---|
| S_{BET} | 7.4 | m²/g |
| Pᵥ | 0.013 | cm³/g |
| P_{d} | 117 | Å |

| | |
|---|---|
| C | 37 |

Capsule C

Preparation of the Silica Capsule—Route (a) Molar Ratio 1 BTB: 100 KOH

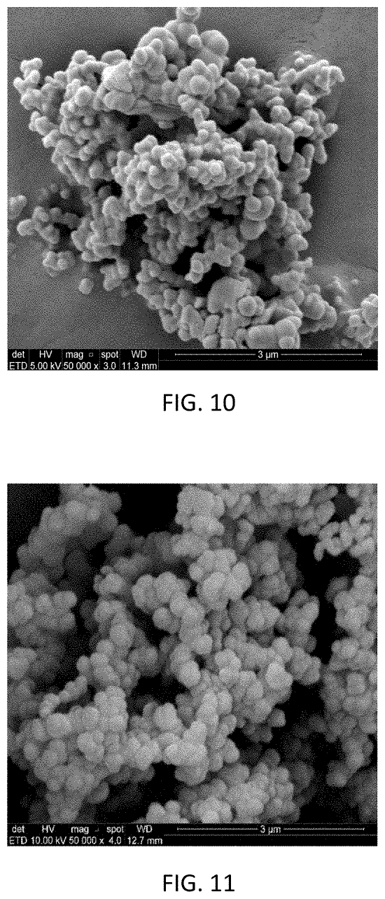

In a 1 L glass, 20 mL of ethanol PA, 8.3 mL of 10 mol/L potassium hydroxide (KOH) solution and 500 mg of bromothymol blue (BTB) were transferred. This reaction mixture was maintained under magnetic stirring for 2 min for conversion of BTB to BTB-converted. Then, to this solution, under magnetic stirring, 80 mL of ethanol PA was added, followed by 50 mL of concentrated ammonium hydroxide solution. Thereafter, 50 mL (280 mmol) of tetraethoxysilane (TEOS) (>98% purity) were added. The solution was kept under constant magnetic stirring for 30 min counted after the addition of TEOS and then the silica was filtered, washed 1 time with 100 mL of ethanol, and oven dried at 100° C. for 8 h. An SEM of the resulting silica capsule (Capsule C) is shown in FIG. 10. Characterization of the Capsule C is provided in Table 6:

TABLE 6

| | | |
|---|---|---|
| Silica Particle Diameter | <1 | μm |
| BTB content by XRF | 17460 | ppm |

| | |
|---|---|
| % (SiO)₆ siloxane rings by ATR-FTIR | 86% |

Nitrogen Adsorption/Desorption Data

| | | |
|---|---|---|
| S_{BET} | 7.4 | m²/g |
| Pᵥ | 0.016 | cm³/g |
| P_{d} | 124 | Å |

| | |
|---|---|
| C | 35 |

Capsule D

Preparation of the Silica Capsule—Route (a) Molar Ratio 1 BTB: 40 NaOH

In a 1 L glass, 20 mL of ethanol PA, 3.4 mL of 10 mol/L sodium hydroxide (NaOH) solution and 500 mg of bromothymol blue (BTB) were transferred. This reaction mixture was maintained under magnetic stirring for 2 min for conversion of BTB to BTB-converted. Then, to this solution, under magnetic stirring, 80 mL of ethanol PA was added, followed by 50 mL of concentrated ammonium hydroxide solution. Thereafter, 50 mL (280 mmol) of tetraethoxysilane (TEOS) (>98% purity) were added. The solution was kept under constant magnetic stirring for 30 min counted after the addition of TEOS and then the silica was filtered, washed 1 time with 100 mL of ethanol, and oven dried at 100° C. for 8 h. An SEM of the resulting silica capsule (Capsule D) is shown in FIG. 11. Characterization of the Capsule D is provided in Table 7:

TABLE 7

| | | |
|---|---|---|
| Silica Particle Diameter | <1 | μm |
| BTB content by XRF | 14818 | ppm |

| | |
|---|---|
| % (SiO)₆ siloxane rings by ATR-FTIR | 79% |

Nitrogen Adsorption/Desorption Data

| | | |
|---|---|---|
| S_{BET} | 8.1 | m²/g |
| Pᵥ | 0.02 | cm³/g |
| P_{d} | 145 | Å |

| | |
|---|---|
| C | 37 |

Capsule E

Preparation of the Silica Capsule—Route (a) Molar Ratio 1 BTB: 80 NaOH

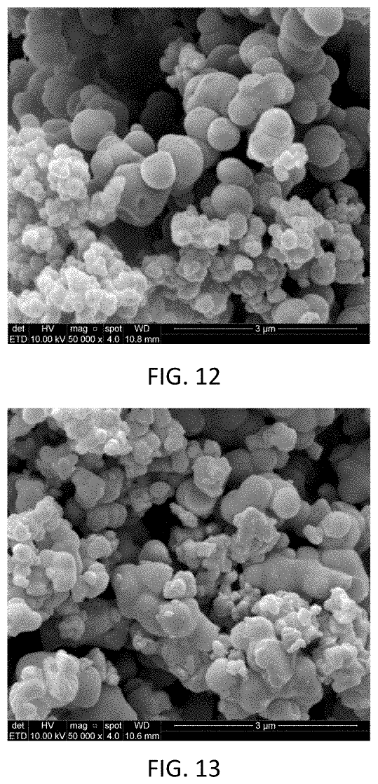

In a 1 L glass, 20 mL of ethanol PA, 6.7 mL of 10 mol/L sodium hydroxide (NaOH) solution and 500 mg of bromothymol blue (BTB) were transferred. This reaction mixture was maintained under magnetic stirring for 2 min for conversion of BTB to BTB-converted. Then, to this solution, under magnetic stirring, 80 mL of ethanol PA was added, followed by 50 mL of concentrated ammonium hydroxide solution. Thereafter, 50 mL (280 mmol) of tetraethoxysilane (TEOS) (>98% purity) were added. The solution was kept under constant magnetic stirring for 30 min counted after the addition of TEOS and then the silica was filtered, washed 1 time with 100 mL of ethanol, and oven dried at 100° C. for 8 h. An SEM of the resulting silica capsule (Capsule E) is shown in FIG. 12. Characterization of the Capsule E is provided in Table 8:

TABLE 8

| | | |
|---|---|---|
| Silica Particle Diameter | <2 | μm |
| BTB content by XRF | 19610 | ppm |

| | |
|---|---|
| % (SiO)₆ siloxane rings by ATR-FTIR | 75% |

Nitrogen Adsorption/Desorption Data

| | | |
|---|---|---|
| S_{BET} | 6.8 | m²/g |
| Pᵥ | 0.013 | cm³/g |
| P_{d} | 124 | Å |

| | |
|---|---|
| C | 31 |

Capsule F

Preparation of the Silica Capsule—Route (a) Molar Ratio 1 BTB: 120 NaOH

In a 1 L glass, 20 mL of ethanol PA, 20 mL of 10 mol/L sodium hydroxide (NaOH) solution and 500 mg of bromothymol blue (BTB) were transferred. This reaction mixture was maintained under magnetic stirring for 2 min for conversion of BTB to BTB-converted. Then, to this solution, under magnetic stirring, 80 mL of ethanol PA was added, followed by 50 mL of concentrated ammonium hydroxide solution. Thereafter, 50 mL (280 mmol) of tetraethoxysilane (TEOS) (>98% purity) were added. The solution was kept under constant magnetic stirring for 30 min counted after the addition of TEOS and then the silica was filtered, washed 1 time with 100 mL of ethanol, and oven dried at 100° C. for 8 h. An SEM of the resulting silica capsule (Capsule F) is shown in FIG. 13. Characterization of the Capsule F is provided in Table 9:

TABLE 9

| | | |
|---|---|---|
| Silica Particle Diameter | <2 | μm |
| BTB content by XRF | 24508 | ppm |

| | |
|---|---|
| % (SiO)₆ siloxane rings by ATR-FTIR | 73% |

Nitrogen Adsorption/Desorption Data

| | | |
|---|---|---|
| S_{BET} | 2.7 | m²/g |
| Pᵥ | 0.0032 | cm³/g |
| P_{d} | 65 | Å |

| | |
|---|---|
| C | 22 |

Capsule G

Preparation of the Silica Capsule—Route (b)

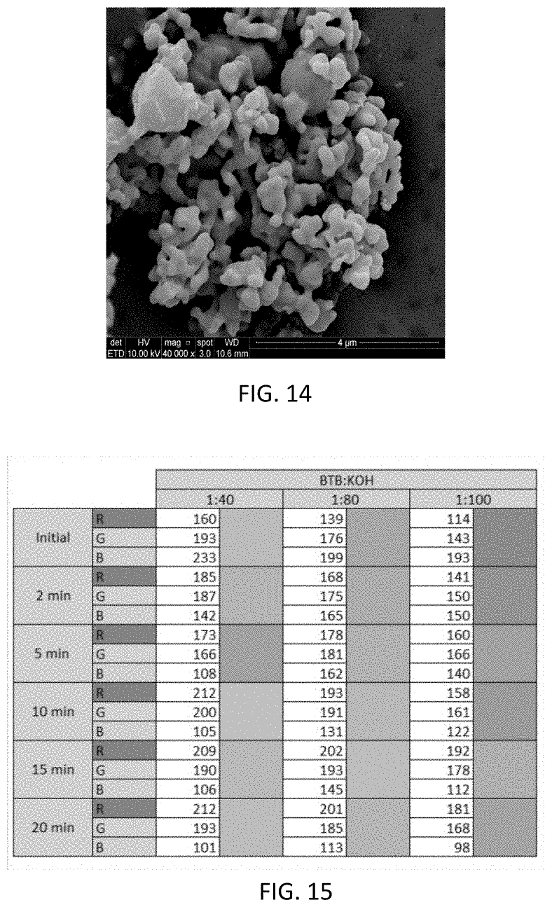

In a 1 L glass, 136 mL of ethanol PA, 14 mL of distilled water, 25 mL of a 0.024 mol/L molar hydrochloric acid solution (0.6 mmol HCl) and 500 mg of bromothymol blue (BTB). After the addition of BTB, the solution acquired a dark yellow color, compatible with the acid form of bromothymol blue and characteristic of a pH<6.0. Subsequently, 50 mL (280 mmol) of tetraethoxysilane (TEOS) (>98% purity) was added to this solution under magnetic stirring. After addition of TEOS, the solution remained dark yellow and the pH ranged from 3.0-4.0. The solution was kept under constant magnetic stirring for 30 min, counted after the addition of TEOS, and then the silica was precipitated with 10 mL of a 10 mol/L aqueous potassium hydroxide solution (KOH). The addition of the potassium hydroxide solution resulted in addition to silica formation in the change in the coloration of the solution from dark yellow to blue. The precipitated silica was suspended under magnetic stirring for a further 30 min and then filtered, washed with 10 mL of 10 mol/L aqueous KOH solution and oven dried at 100° C. for 8 h. An SEM of the resulting silica capsule (Capsule G) is shown in FIG. 14. Characterization of the Capsule G is provided in Table 10:

TABLE 10

| | | |
|---|---|---|
| Silica Particle Diameter | <10 | μm |
| BTB content by XRF | 4298 | ppm |

| | |
|---|---|
| % (SiO)₆ siloxane rings by ATR-FTIR | 94% |

Nitrogen Adsorption/Desorption Data

| | | |
|---|---|---|
| S_{BET} | 2.5 | m²/g |
| Pᵥ | 0.0028 | cm³/g |
| P_{d} | 62 | Å |

| | |
|---|---|
| C | 44 |

Change Color—Silica Capsules

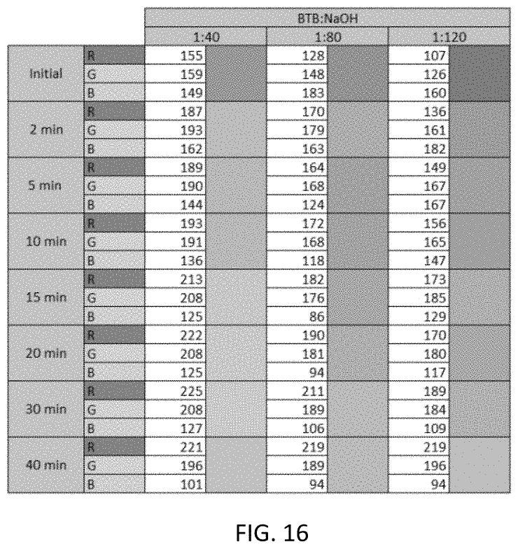

Studies of color change with the simulant medium were carried upon Capsules A-F together to volatile acetic acid in different times. The capsules were collected in cuvettes, and the color was measured through the colorimeter, at room temperature (−23° C.). Data from Cielab L, a, b were changed to RGB system, as shown in FIGS. 15 and 16.

### Examples 1, 2, 3—Formulation and Processing of the Materials—Plate

Examples 1, 2, and 3 were formulated with 50 wt % of EVA HM728, ˜49.5 wt % of HDPE HD7000C, 0.5 wt % of Capsules A, B, and C (respectively), and 500 ppm of calcium stearate (matrix stabilizer), which were processed via mixing chamber using rolling-rotors, with a rotor speed of 100 rpm, set temperature of 180° C., and a mixing time of 2 minutes. After compression molding (˜30 seconds, ˜1 bar), the polymeric mass was taken directly from the mixing chamber into a thin plate (1 mm).

### Example 4—Formulation and Processing of the Materials—Plate

Example 4 was formulated with 15 wt % of EVA HM728, ˜84.5 wt % of HDPE HD7000C, 0.5% wt of Capsule B, and 500 ppm of calcium stearate (matrix stabilizer), which was processed via mixing chamber using rolling-rotors, with a rotor speed of 100 rpm, set temperature of 180° C., and a mixing time of 2 minutes. After compression molding (˜30 seconds, ˜1 bar), the polymeric mass was taken directly from the mixing chamber into a thin plate (1 mm).

### Example 5—Formulation and Processing of the Materials—Plate

Example 5 was formulated with 35 wt % of EVA HM728, ˜64.5 wt % of HDPE HD7000C, 0.5 wt % of Capsules B, and 500 ppm of calcium stearate (matrix stabilizer), which was processed via mixing chamber using rolling-rotors, with a rotor speed of 100 rpm, set temperature of 180° C., and a mixing time of 2 minutes. After compression molding (˜30 seconds, ˜1 bar), the polymeric mass was taken directly from the mixing chamber into a thin plate (1 mm).

### Examples 6, 7, 8—Formulation and Processing of the Materials—Plate

Examples 6, 7, and 8 were formulated with 50 wt % of EVA HM728, ˜49.5 wt % of HDPE HD7000C, 0.5 wt % of Capsules D, E, and F (respectively), and 500 ppm of calcium stearate (matrix stabilizer), which were processed via mixing chamber using rolling-rotors, with a rotor speed of 100 rpm, set temperature of 180° C., and a mixing time of 2 minutes. After compression molding (˜30 seconds, ˜1 bar), the polymeric mass was taken directly from the mixing chamber into a thin plate (1 mm).

### Example 9—Formulation and Processing of the Materials—Plate

Example 9 was formulated with 50 wt % of EVA HM728, ˜49.5 wt % of HDPE HD7000C, 1.0 wt % of Capsule E, and 500 ppm of calcium stearate (matrix stabilizer), was processed via mixing chamber using rolling-rotors, with a rotor speed of 100 rpm, set temperature of 180° C., and a mixing time of 2 minutes. After compression molding (˜30 seconds, ˜1 bar), the polymeric mass was taken directly from the mixing chamber into a thin plate (1 mm).

### Example 10—Formulation and Processing of the Materials—Bottle

Example 10 was formulated with 49 wt % of EVA VA4018R, 49 wt % of HDPE BS002W, and 2.0 wt % of Capsules G, which was processed in a twin screw extruder, using a screw speed of 350 rpm, throughput rate of 3 kg/h, and a die with one hole. The heating zones were set to the following temperatures: 120, 170, 190, 200, 210, 210, 210° C. (melt temperature was around 226° C.), and the pH of the cooling water bath was maintained around 10. The material was pelletized, and then processed via EBM, with a screw speed of 20 rpm, a temperature profile ending in 190° C., mold temperature of 15° C., blow pressure and support air of 2 bar, cooling and blow time of 9 seconds and a total cycle time of 13.5 seconds, where bottles with 25.5 grams and wall thickness of approximately 0.7 mm were produced.

### Example 11: Formulation and Processing of the Materials—3D Printed Bottle

Example 11 was formulated with 30 wt % of EVA HM2528, ˜69.5 wt % of HDPE SHC7260 (Green polyethylene), 0.5 wt % of Capsules B, and 300 ppm of zinc stearate (matrix stabilizer), which was processed in a twin screw extruder, using a screw speed of 220 rpm, throughput rate of 4 kg/h, and a die with two holes. The heating zones were set to the following temperatures: 60, 120, 135, 150, 160, 160, 160° C. (melt temperature was 169° C.), and the pH of the cooling water bath was maintained around 8. The material was pelletized, re-extruded using a single screw extrusion (melt temperature ˜180° C., through a die with one hole), in order to obtain a filament to produce a bottle via 3D Printing (FDM (Fused deposition modeling), with a 3D Printer LeapFrog—Bolt Pro. The processing conditions of the 3D printing are provided in Table 11 below.

TABLE 11

| Nozzle diameter | 0.35 | mm |
|---|---|---|
| Extrusion Multiplier | 1.0 | |
| Primary layer height | 0.15 | mm |
| Skirt Outlines | 25 | |
| Infill | 100% | |
| Internal Fill Pattern | Full Honeycomb | |
| Infill Extrusion Width | 1.75 ± 0.05 | mm |
| Printing Speed | 4000 | mm/min |
| Overlap | 30% | |
| Support | 0 | |
| Extruder Temperature | 230° | C. |
| Bed Temperature | 25° | C. |
| Cooling | Without | |
| Print Quality | Mid | |
| Print Time | 7 | h |

| | |
|---|---|
| Bed film or adhesive | Yes |

### Example 12—Formulation and Processing of the Materials—Masterbatch

Example 12 was formulated to be a masterbatch formulation with 90 wt % of EVA HM2528, 10 wt % of Capsule B compact with mineral oil (25% oil in the mix), which was processed in a twin screw extruder, using a screw speed of 200 rpm, throughput rate of 2 kg/h, a die with one hole, the heating zones with the following temperatures 80, 110, 125, 140, 150, 150, 150° C. (where the melt temperature was 160° C.), and the pH of the cooling water bath (in which the strand passed through) was maintained around 10.

### Example 13—Formulation and Processing of the Materials—Dilution

Example 13 was formulated with 90 wt % of EVA HM728, 10 wt % of the Masterbatch formulation of Example 12. The formulation was processed in a twin screw extruder, using a screw speed of 250 rpm, throughput rate of 3 kg/h, a die with one hole, the heating zones with the following temperatures 80, 110, 125, 140, 150, 150, 150° C. (where the melt temperature was 160° C.), and the pH of the cooling water bath (in which the strand passed through) was maintained around 10.

### Examples 14, 16, 18 and 20—Formulation and Processing of the Materials—Dilution

Examples 14, 16, 18, and 20 were formulated with 90 wt % of HD7000C (Ex. 14) or FLEXUS 9200 (Ex. 16) or BC818 (Ex. 18) or HSC7260 green (Ex. 20), 10 wt % of the Masterbatch formulation (Ex. 12). The formulations were processed in a twin screw extruder, using a screw speed of 250 rpm, throughput rate of 3 kg/h, a die with one hole, the heating zones with the following temperatures 80, 135, 150, 160, 170, 170, 170° C. (where the melt temperature was 180° C.), and the pH of the cooling water bath (in which the strand passed through) was maintained around 10. HM728 is an EVA grade used in adhesives and expanded plates, HD7000C is a PE grade used in blow molding, FLEXUS 9200 is a PE grade used in films, BC818 is a PE grade used in injection molding and films, HSC7260 is a biobased PE grade used in injection molding, CP939 is a PP grade used in injection molding.

### Example 15, 17, 19 and 21—Formulation and Processing of the Materials—Dilution

Examples 15, 17, 19, and 21 were formulated with 50 wt % of HD7000C (Ex. 15) or FLEXUS 9200 (Ex. 17) or BC818 (Ex. 19) or HSC7260 green (Ex. 21), 10 wt % of the Masterbatch (Ex. 12), and 40 wt % of EVA HM728. The formulations were processed in a twin screw extruder, using a screw speed of 250 rpm, throughput rate of 3 kg/h, a die with one hole, the heating zones with the following temperatures 80, 135, 150, 160, 170, 170, 170° C. (where the melt temperature was 180° C.), and the pH of the cooling water bath (in which the strand passed through) was maintained around 10.

### Example 22—Formulation and Processing of the Materials—Dilution

Example 22 was formulated with 90 wt % of ICP CP393 and 10 wt % of the Masterbatch (Ex. 12), which was processed in a twin screw extruder, using a screw speed of 250 rpm, throughput rate of 3 kg/h, a die with one hole, the heating zones with the following temperatures 100, 180, 180, 180, 190, 190, 190° C. (where the melt temperature was 200° C.), and the pH of the cooling water bath (in which the strand passed through) was maintained around 10.

### Example 23—Formulation and Processing of the Materials—Dilution

Example 23 was formulated with 50 wt % of ICP CP393, 10 wt % of the Masterbatch (Ex. 12), 40 wt % of EVA HM728, which was processed in a twin screw extruder, using a screw speed of 250 rpm, throughput rate of 3 kg/h, a die with one hole, the heating zones with the following temperatures 100, 180, 180, 180, 190, 190, 190° C. (where the melt temperature was 200° C.), and the pH of the cooling water bath (in which the strand passed through) was maintained around 10.

Change Color in the Formulations—Plates and Bottles

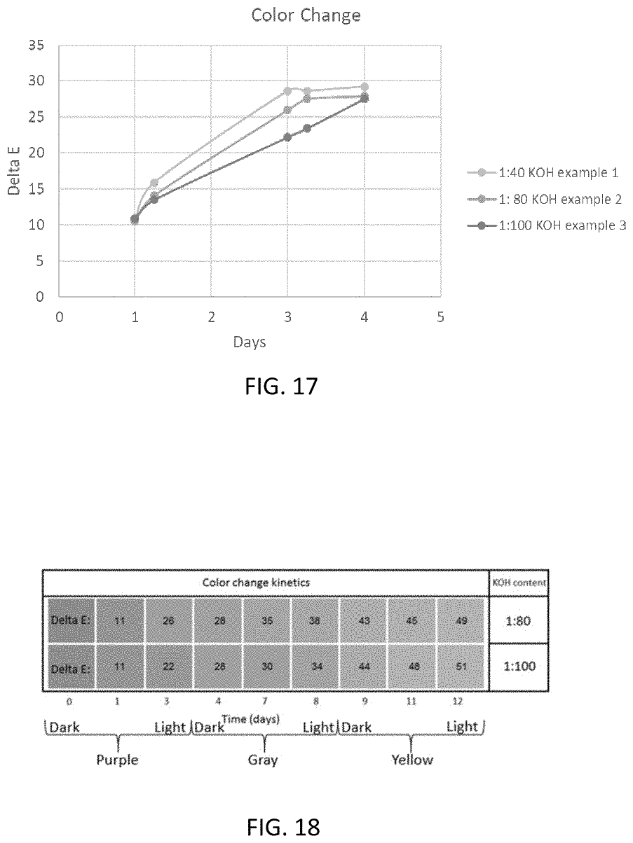

Studies of color change with a simulant medium were carried by filling the bottles and plates from polymeric formulation (described in the examples) to a certain level with whole pasteurized milk, and then, the color was measured through time using a colorimeter, at room temperature (−23° C.), in the same spot for 3 days or more. The results are shown in Table 12 below. Further, the comparative color change for Examples 1-3 (comparing Capsules A-C) is shown in FIG. 17. The color changes are more noticeable in the samples with lower molar ratio between the indicator and the base used in the synthesis of the capsules as can be observed by the largest delta E found. The color changes were faster for the capsules synthesized with 1:80 KOH (Capsules B in Ex. 2) than for capsules synthesized with 1:100 KOH (Capsules C in Ex. 3), as it was expected, because of the increased amount of base used in Capsules C, as seen in FIG. 18. Thus, the acid generated from the milk as it spoils, first changes the pH of the capsules followed by changing the color of the indicator.

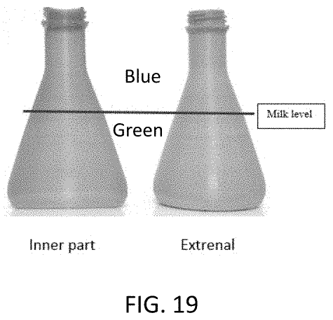

Further, photographs of the printed bottle, shown in FIG. 19 and example 11 (a) showed a transition from a blue color to a green color, which were apparent both internally as well as externally (though, not to the same extent as the internal change).

TABLE 12

| | | | | | | Initial color | Final color after | |
|---|---|---|---|---|---|---|---|---|
| Examples and | | Blend | | Silica | | 0 h (CIELab color | 72 h (CIELab color | Color ΔE |
| synthesis | Base Ratio | (wt % and | | capsule | Shape of | space: L; a; b) | space: L; a; b) | (data from |
| route | Indicator:base | polar phase) | Resin base | (wt %) | packing | pH = 6.8 | pH = 4.4 | CIELab) |
| 1 (a) | 1:40 | 50 HM728 | HD7000C | 0.5 | plate | 54.8; 6.0; −19.2 | 64.1; −3.2; 6.2 | 29 |
| | (KOH) | | | | | | | |
| 2 (a) | 1:80 | 50 HM728 | HD7000C | 0.5 | plate | 58.0; 5.1. −19.8 | 66.2; −2.6; 3.7 | 26 |
| | (KOH) | | | | | | | |
| 3 (a) | 1:100 | 50 HM728 | HD7000C | 0.5 | plate | 58.7; 6.6; −22.81 | 62.9; −0.5; −2.2 | 22 |
| | (KOH) | | | | | | | |
| 4 (a) | 1:80 | 15 HM728 | HD7000C | 0.5 | plate | 69.4; −9.4; −17.4 | 77.4; −5.5; 5.9 | 25 |
| | (KOH) | | | | | | | |
| 5 (a) | 1:80 | 35 HM728 | HD7000C | 0.5 | plate | 68.5; −11.7; −18.1 | 79.0; −7.1; 14.4 | 34 |
| | (KOH) | | | | | | | |
| 6 (a) | 1:40 | 50 HM728 | HD7000C | 0.5 | plate | 73.0; 12.1; 5.2 | 80.3; −6.2; 21.8 | 19 |
| | (NaOH) | | | | | | | |
| 7(a) | 1:80 | 50 HM728 | HD7000C | 0.5 | plate | 61.8; −7.6; −8.9 | 76.6; −3.5; 27.0 | 37 |
| | (NaOH) | | | | | | | |
| 8 (a) | 1:120 | 50 HM728 | HD7000C | 0.5 | plate | 69.0; −12.6; −6.1 | 78.5; −7.5; 17.3 | 26 |
| | (NaOH) | | | | | | | |
| 9 (a) | 1:80 | 50 HM728 | HD7000C | 1.0 | plate | 55.9; −10.9; −17.5 | 66.8; −5.8; 15.7 | 36 |
| | (NaOH) | | | | | | | |
| 10 (b) | x | 50 VA4018R | BS002W | 2.0 | Bottle | 66.9; −7.6; 16.0 | 73.3; −3.0; 26.9 | 14 |
| 11 (a) | 1:80 | 30 HM728 | HSC7260 | 0.5 | Bottle | 57.3; −6.8; −22.5 | 60.9; −4.1; 9.4 | 13 |
| | (KOH) | | green | | 3D | | | |

Change Color—Formulations from Master Dilution

Studies of color change with the simulant medium were carried upon all plates with exposure to volatile acetic acid. The color was measured through time using a colorimeter, at room temperature (˜23° C.), in the same spot for before and after exposing the plates to the volatile acetic acid for 5 h. Results are shown in Table 13 below.

TABLE 13

| | | | | EVA | Silica | | Initial color | Final color after | |
|---|---|---|---|---|---|---|---|---|---|
| | | Resin | Master | HM728 | capsule | Shape of | 0 h | 5 h | |
| Ex. | Grade | (wt %) | (wt %) | (wt %) | (wt %) | packaging | (CieLab: L, a, b) | (CieLab: L, a, b) | Color ΔE |
| 12 | Master | EVA 90 | x | x | 10.0* | Plate | X | X | x |
| | Intelligent | | | | | | | | |
| | additive | | | | | | | | |
| | HM2528 | | | | | | | | |
| 13 | HM728 | EVA 90 | 10 | x | 1..0 | Plate | 64.5; −30.2; −21.7 | 83.3; −5.8; −50.8 | 78..8 |
| 14 | HD7000C | PE 90 | 10 | 0 | 1..0 | Plate | 48.7; −6.2; −17.5 | 52.7; −7.5; −4.4 | 13..8 |
| 15 | HD7000C | PE 50 | 10 | 40 | 1..0 | Plate | 51.8; −5.4; −30.2 | 85.3; 1.5; 53.8 | 91.1 |
| 16 | FLEXUS | PE 90 | 10 | 0 | 1..0 | Plate | 55.5; −7.2; −9.6 | 61.7; −6.0; 15.5 | 25.8 |
| | 9200 | | | | | | | | |
| 17 | FLEXUS | PE 50 | 10 | 40 | 1..0 | Plate | 51.6; −14.3; −24.4 | 81.6; −0.5; 58.9 | 89.4 |
| | 9200 | | | | | | | | |
| 18 | BC818 | PE 90 | 10 | 0 | 1..0 | Plate | 51.3; 3.3; −29.4 | 60.9; −4.1; 9.4 | 40.6 |
| 19 | BC818 | PE 50 | 10 | 40 | 1..0 | Plate | 50.8; −18.4; −22.6 | 62.6; −19.8; 27.9 | 51.8 |
| 20 | HSC7260 | PE 90 | 10 | 0 | 1..0 | plate | 49.5; −1.7; −19.1 | 51.1; −5.2; −5.6 | 14.1 |
| 21 | HSC7260 | PE 50 | 10 | 0 | 1..0 | Plate | 51.0; 4.6; −28.4 | 72.8; −3.4; 33.7 | 66.3 |
| 22 | CP393 | PP 90 | 10 | 40 | 1..0 | Plate | 50.2; 6.3; −24.6 | 53.6; −2.4; −5.1 | 20.2 |
| 23 | CP393 | PP 50 | 10 | 40 | 1..0 | Plate | 56.0; −7.5; −22.0 | 81.4; −0.3; 55.1 | 81.5 |

*Value not measured, based in mass balance.

From the above, it is noted that expressive results of delta E were found for the different formulations. For formulations richer in the polar resin, delta E values are higher. Surprisingly, the formulation of example 15 outperformed the results of pure polar resin (example 13), indicating that there may be a synergy between the polymers to consider.

As shown, the balance between base and indicator ratio and amount of capsule used versus polymer composition, plus the nature of the trigger and its concentration release during a degradation process, are factors can be modulated to obtain the color change when a product containing within packaging is inappropriate for consumption or has reached a critical concentration. Thus, as shown, a color change may alert a consumer or bystander as to a change in one or more applications including but not limited to food packaging.

Although the preceding description is described herein with reference to particular means, materials and embodiments, it is not intended to be limited to the particulars disclosed herein; rather, it extends to all functionally equivalent structures, methods and uses, such as are within the scope of the appended claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. An encapsulated indicator, comprising:
a silica matrix encapsulating an acid-base indicator, wherein the acid-base indicator is present in its basic form.

2. The encapsulated indicator of claim 1, wherein a molar proportion between the acid-base indicator and an alkaline compound ranges from 1:20 to 1:200.

3. The encapsulated indicator of claim 1, wherein the acid-base indicator is present in an amount ranging from 1000 to 50000 ppm.

4. The encapsulated indicator of claim 1, wherein the encapsulated indicator has a spheroidal morphology with average particle size, measured by FEG-SEM, ranging from 0.1 to 50 micrometers.

5. The encapsulated indicator of claim 1, wherein the silica matrix has a relative percentage of (SiO)₆, measured by ATR-FTIR, ranging from 60 to 96%.

6. The encapsulated indicator of claim 1, wherein the encapsulated indicator has a specific surface area ranging from 0.5 to 300 m²/g.

7. The encapsulated indicator of claim 1, wherein the encapsulated indicator has an average pore diameter ranging from 50 to 500 Å.

8. The encapsulated indicator of claim 1, wherein the encapsulated indicator has a BET constant (C) ranging from 10 to 500.

9. An intelligent polymer composition, comprising:
a polymer matrix; and
an encapsulated indicator dispersed in the polymer matrix, wherein the encapsulated indicator comprises: a silica matrix encapsulating an acid-base indicator, wherein the acid-base indicator is present in its basic form.

10. An intelligent polymer composition, comprising:
a matrix polymer and an encapsulated indicator, wherein the indicator triggers a color change in the intelligent polymeric composition when exposed to an external stimulus.

11. The intelligent polymer composition of claim 10, wherein the indicator is an acid-base indicator.

12. The intelligent polymer composition of claim 10, wherein the encapsulated indicator is present at a percent by weight of the intelligent polymer composition that ranges from 0.1 wt % to 20 wt %.

13. The intelligent polymer composition of claim 10, wherein the composition exhibits a ΔE of at least 8 when in contact with the external stimulus.

14. The intelligent polymer composition of claim 10, wherein the composition exhibits a ΔE of at least 12 when in contact with the external stimulus.

15. The intelligent polymer composition of claim 10, wherein the external stimulus is a change in pH.

16. The intelligent polymer composition of claim 10, wherein the indicator is encapsulated by an encapsulant prepared from the reaction of one or more selected from a group consisting of silicon alkoxides.

17. The intelligent polymer composition of claim 10, wherein the indicator is encapsulated in a silica matrix.

18. The intelligent polymer composition of claim 10, wherein the indicator is converted to a basic form.

19. The intelligent polymer composition of claim 10, wherein the indicator is converted to a basic form prior to, during or after encapsulation.

20. The intelligent polymer composition of claim 10, wherein the matrix polymer comprises a polyolefin or a blend of polyolefins.

21. The intelligent polymer composition of claim 10, wherein the matrix polymer comprises a polar polymer or a blend of polar polymers.

22. The intelligent polymer composition of claim 10, wherein the matrix polymer comprises a blend of polyolefin and a polar polymer.

23. The intelligent polymer composition of claim 10, wherein the polar polymer comprises an ethylene vinyl acetate copolymer.

24. The intelligent polymer composition of claim 10, wherein the intelligent polymer composition further comprises a matrix stabilizer.

25. A packaging material, comprising:
a packaging material formed from an intelligent polymer composition of claim 9, wherein the intelligent polymer composition is configured to contact a material enclosed within the packaging material.

26. The packaging material of claim 25, wherein the external stimulus is a change in pH induced by microbial spoilage.

27. The packaging material of claim 25, wherein the packaging material includes an internal reservoir for storage, wherein the packaging material forms a portion of an inner surface within the internal reservoir.

28. The packaging material of claim 25, wherein the packaging material comprises a first portion formed from the intelligent polymer composition and a second portion formed from a second polymer composition.

29. The packaging material of claim 25, wherein the packaging material is a multilayer packaging comprising an innermost layer and one or more outer layers, wherein the innermost layer is formed by the intelligent polymer composition and the one or more outer layers are formed by materials with a transparency sufficient to detect the color change of the intelligent polymer composition.

30. The packaging material of claim 25, wherein the packaging material is a bottle.

31. The packaging material of claim 25, wherein the material enclosed within the packaging material is milk.

32. A packaging material, comprising:
a packaging material formed from an intelligent polymer composition of claim 10, wherein the intelligent polymer composition is configured to contact a material enclosed within the packaging material.

33. A method of forming encapsulated indicator, comprising:
reacting at least one acid-base indicator with a non-volatile alkaline compound to convert the acid-base indicator to its basic form;
combining the acid-base indicator with a silica precursor; and
precipitating the silica precursor to form a silica matrix encapsulating the acid-base indicator.

34. The method of claim 33, wherein the acid-base indicator is converted to its basic form prior to the combining.

35. The method of claim 33, wherein the acid-base indicator is converted to its basic form prior, during or after the precipitating.

36. A method of forming an intelligent polymer composition, comprising:
dispersing an encapsulated indicator in a polymer matrix to form the intelligent polymer composition of claim 9.

37. The method of claim 36, wherein the dispersing forms a masterbatch composition.

38. The method of claim 37, further comprising: combining the masterbatch composition with an additional polymer matrix.

39. A method of forming an intelligent polymer composition, comprising:
dispersing an encapsulated indicator in a polymer matrix to form the intelligent polymer composition of claim 10.

40. A method, comprising:
forming a packaging material from an intelligent polymer composition of claim 9.

41. The method of claim 40, wherein forming a packaging material comprises forming a first portion and an internal reservoir, and wherein the first portion of the packaging material forms a portion of an inner surface within the internal reservoir.

42. The method of claim 40, wherein forming a packaging material comprises processing the intelligent polymer composition using a method selected from a group consisting of extrusion, coextrusion, extrusion coating, extrusion lamination, blown film extrusion, cast film extrusion, injection molding, blow molding, injection-blow molding, rotomolding, pultrusion, compression molding, solution casting, thermoforming, and 3D printing.

43. A method, comprising:
forming a packaging material from an intelligent polymer composition of claim 10.

44. A method, comprising:
manufacturing at least a first portion of an entire article using an additive manufacturing technique with an intelligent polymer composition, wherein the intelligent polymer composition comprises a matrix polymer and an indicator, wherein the indicator triggers a color change in the intelligent polymeric composition when exposed to an external stimulus.

45. The method of claim 44, wherein the indicator is encapsulated.

46. A printed article, wherein the article comprises:
a plurality of printed layers, with at least a portion of the plurality of layers comprising an intelligent polymer composition, wherein the intelligent polymer composition comprises a matrix polymer and an indicator, wherein the indicator triggers a color change in the intelligent polymeric composition when exposed to an external stimulus.

47. The printed article of claim 46, wherein another portion of the plurality of printed layers comprise a second polymer composition.

48. The printed article of claim 46, wherein the indicator is encapsulated.
